(19) United States
(12) Patent Application Publication
(10) Pub. No.: US 2008/0162522 A1
(43) Pub. Date: Jul. 3, 2008

(54) Methods and apparatuses for compaction and/or decompaction

(76) Inventors: Guei-Yuan Lueh, San Jose, CA (US); Hong Jiang, El Dorado Hills, CA (US); Andrew T. Riffel, Davis, CA (US); Bixia Zheng, Palo Alto, CA (US); Chu-Cheow Lim, Santa Clara, CA (US); Milind Girkar, Sunnyvale, CA (US); David C. Sehr, Cupertino, CA (US); Thomas A. Piazza, Granite Bay, CA (US)

Correspondence Address: BUCKLEY, MASCHOFF & TALWALKAR LLC, 50 LOCUST AVENUE, NEW CANAAN, CT, 06840, US

(21) Appl. No.: 11/648,260

(22) Filed: Dec. 29, 2006

(51) Int. Cl. G06F 17/30

(52) U.S. Cl. 707/101

(57) ABSTRACT

In some embodiments, a data structure may be received in a first processing system. The data structure may represent a plurality of instructions for a second processing system. For at least one instruction of the plurality of instructions, a determination may be made as to whether the instruction can be replaced by a compact instruction for the second processing system. A compact instruction may be generated if the instruction can be replaced by a compact instruction. In some embodiments, an instruction may be received in a processing system. A determination may be made as to whether the instruction is a compact instruction. A decompacted instruction may be generated if the instruction is a compact instruction.

### BACKGROUND

Many processing systems execute instructions. The ability to generate, store, and/or access instructions is thus desirable.

In some processing systems, a Single Instruction, Multiple Data (SIMD) instruction is simultaneously executed for multiple operands of data in a single instruction period. For example, an eight-channel SIMD execution engine might simultaneously execute an instruction for eight 32-bit operands of data, each operand being mapped to a unique compute channel of the SIMD execution engine. An ability to generate, store and/or access such instructions may thus be desirable.

### BRIEF DESCRIPTION OF THE DRAWINGS

FIG. 1 is a block diagram of a processing system, according to some embodiments.

FIG. 2 is a block diagram of a system having first and second processing systems, according to some embodiments.

FIG. 3 is a flowchart of a method, according to some embodiments.

FIG. 4 is a block diagram of the first processing system of FIG. 2, according to some embodiments.

FIG. 5 illustrates a data structure, according to some embodiments.

FIG. 6 illustrates a data structure, according to some embodiments.

FIG. 7 illustrates a data structure, according to some embodiments.

FIG. 8 is a block diagram of a compactor of the first processing system of FIG. 4, according to some embodiments.

FIG. 9 illustrates a data structure, according to some embodiments.

FIG. 10 illustrates a data structure, according to some embodiments.

FIG. 11 illustrates a data structure, according to some embodiments.

FIG. 12 illustrates a stuff instruction format, according to some embodiments.

FIG. 13 is a flowchart of a method, according to some embodiments.

FIG. 14 is a flowchart of a method, according to some embodiments.

FIG. 15 is a flowchart of a method, according to some embodiments.

FIG. 16 is a schematic representation of a compaction, according to some embodiments.

FIG. 17 is a block diagram of a portion of the second processing system of FIG. 2, according to some embodiments.

FIG. 18 is a flowchart of a method, according to some embodiments.

FIG. 19 is a schematic representation of a portion of a decompactor of the second processing system of FIG. 18.

FIG. 20 is a schematic representation of a portion of a decompactor of the second processing system of FIG. 18.

FIG. 21 is a block diagram of a processing system.

FIG. 22 is a block diagram of a processing system.

FIG. 22 is a block diagram of a system that includes a first processing system and a second processing system.

FIG. 23 illustrates an instruction and a register file for a processing system.

FIG. 24 illustrates an instruction and a register file for a processing system according to some embodiments.

FIG. 25 illustrates execution channel mapping in a register file according to some embodiments.

FIG. 26 illustrates a region description including a horizontal stride according to some embodiments.

FIG. 27 illustrates a region description for word type data elements according to some embodiments.

FIG. 28 illustrates a region description including a vertical stride according to some embodiments.

FIG. 29 illustrates a region description including a vertical stride of zero according to some embodiments.

FIG. 30 illustrates a region description according to some embodiments.

FIG. 31 illustrates a region description wherein both the horizontal and vertical strides are zero according to some embodiments.

FIG. 32 illustrates region descriptions according to some embodiments.

FIG. 33 is a block diagram of a system according to some embodiments.

FIG. 34 is a list of instructions for a program that may be executed in a processing system according to some embodiments.

FIG. 35 is a block diagram representation of a data structure according to some embodiments.

FIGS. 36-39 are block diagram representations of data structures according to some embodiments.

FIG. 40 is a block diagram representation of compaction according to some embodiments.

FIG. 41 is a block diagram representation of decompaction according to some embodiments.

### DETAILED DESCRIPTION

Some embodiments described herein are associated with a “processing system.” As used herein, the phrase “processing system” may refer to any system that processes data. In some embodiments, a processing system includes one or more devices. In some embodiments, a processing system is associated with a graphics engine that processes graphics data and/or other types of media information. In some cases, the performance of a processing system may be improved with the use of a SIMD execution engine. For example, a SIMD execution engine might simultaneously execute a single floating point SIMD instruction for multiple channels of data (e.g., to accelerate the transformation and/or rendering three-dimensional geometric shapes). Other examples of processing systems include a Central Processing Unit (CPU) and a Digital Signal Processor (DSP).

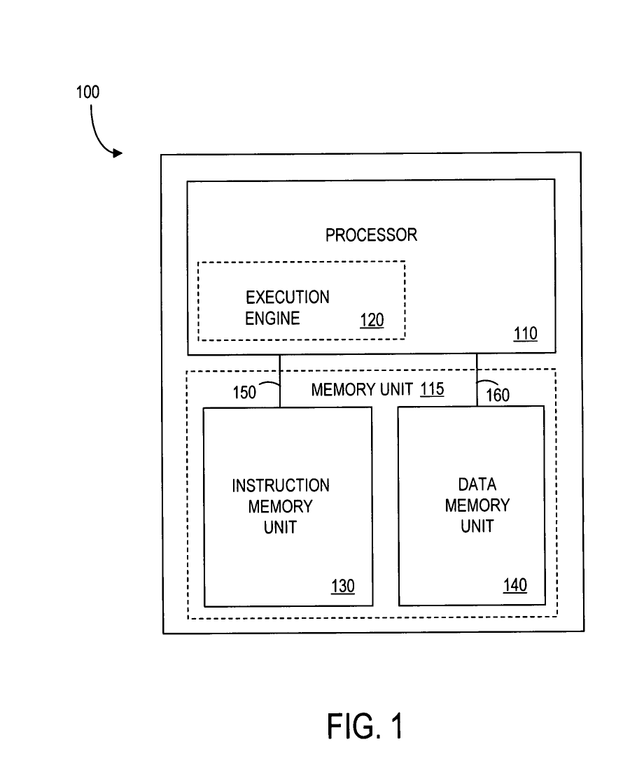

FIG. 1 is a block diagram of a processing system 100 according to some embodiments. The processing system 100 includes a processor 110 and a memory unit 115. In some embodiments, the processor 110 may include an execution engine 120 and may be associated with, for example, a general purpose processor, a digital signal processor, a media processor, a graphics processor and/or a communication processor.

The memory unit 115 may store instructions and/or data (e.g., scalars and vectors associated with a two-dimensional image, a three-dimensional image, and/or a moving image). In some embodiments, the memory unit 115 includes an instruction memory unit 130 and data memory unit 140, which may store instructions and data, respectively. The instruction memory unit 130 and/or the data memory unit 140 might be associated with separate instruction and data caches, a shared instruction and data cache, separate instruction and data caches backed by a common shared cache, or any other cache hierarchy. In some embodiments, the instruction memory unit 130 and/or the data memory unit 140 comprise one or more RAM units. In some embodiments, the memory unit 115, or one or more portions thereof (e.g., the instruction memory unit 130 and/or the data memory unit 140) comprises a hard disk drive (e.g., to store and provide media information) and/or a non-volatile memory such as FLASH memory (e.g., to store and provide instructions and data).

The memory unit 115 may be coupled to the processor 110 through one or more communication links. In the illustrated embodiment, for example, the instruction memory unit 130 and the data memory unit 140 are coupled to the processor through a first communication link 150 and a second communication link 160, respectively.

As used herein, a processor may be implemented in any manner. For example, a processor may be programmable or non programmable, general purpose or special purpose, dedicated or non dedicated, distributed or non distributed, shared or not shared, and/or any combination thereof. If the processor has two or more distributed portions, the two or more portions may communicate with one another through a communication link. A processor may include, for example, but is not limited to, hardware, software, firmware, hardwired circuits and/or any combination thereof.

Also, as used herein, a communication link may comprise any type of communication link, for example, but not limited to, wired (e.g., conductors, fiber optic cables) or wireless (e.g., acoustic links, electromagnetic links or any combination thereof including, for example, but not limited to microwave links, satellite links, infrared links), and/or combinations thereof, each of which may be public or private, dedicated and/or shared (e.g., a network). A communication link may or may not be a permanent communication link. A communication link may support any type of information in any form, for example, but not limited to, analog and/or digital (e.g., a sequence of binary values, i.e. a bit string) signal(s) in serial and/or in parallel form. The information may or may not be divided into blocks. If divided into blocks, the amount of information in a block may be predetermined or determined dynamically, and/or may be fixed (e.g., uniform) or variable. A communication link may employ a protocol or combination of protocols including, for example, but not limited to the Internet Protocol.

As stated above, many processing systems execute instructions. The ability to generate, store and/or access instructions is thus desirable.

In some embodiments, a first processing system is used in generating instructions for a second processing system.

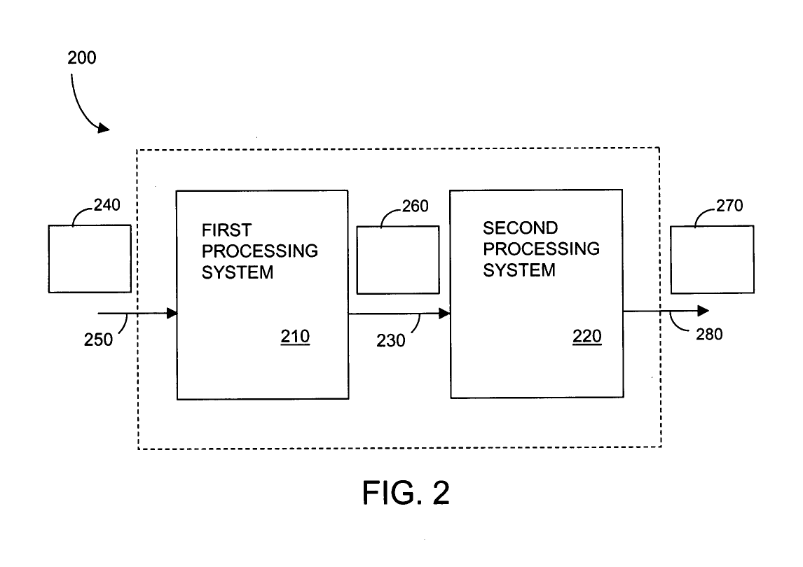

FIG. 2 is a block diagram of a system 200 according to some embodiments. Referring to FIG. 2, the system 200 includes a first processing system 210 and a second processing system 220. The first processing system 210 and the second processing system 22 may be coupled to one another, e.g., via a first communication link 230.

According to some embodiments, the first processing system 210 is used in generating instructions for the second processing system 220. In that regard, in some embodiments, the system 200 may receive an input or first data structure indicated at 240. The first data structure 240 may be received through a second communication link 250 and may include, but is not limited to, a first plurality of instructions, which may include instructions in a first language, e.g., a high level language or an assembly language.

The first data structure 240 may be supplied to an input of the first processing system 210, which may include a compiler and/or assembler that compiles and/or assembles one or more parts of the first data structure 240 in accordance with one or more requirements associated with the second processing system 220. An output of the first processing system 210 may supply a second data structure indicated at 260. The second data structure 260 may include, but is not limited to, a second plurality of instructions, which may include instructions in a second language, e.g., a machine language.

The second data structure 260 may be supplied through the first communication link 230 to an input of the second processing system 220. The second processing system may execute one or more of the second plurality of instructions and may generate data indicated at 270. The second processing system 160 may be coupled to one or more external devices (not shown) through one or more communication links, e.g., a third communication link 280, and may supply some or all of the data 270 to one or more of such external devices through one or more of such communication links.

In some embodiments, the first processing system 210 and/or the second processing system 220 may have a configuration that is the same as and/or similar to one or more of the processing systems disclosed herein, for example, the processing system 100 illustrated in FIG. 1.

In some embodiments, the first processing system 210 and/or the second processing system 220 may be used without the other. For example, the first processing system 210 may be used without the second processing system 220. The second processing system 220 may be used without the first processing system 210.

In some embodiments, one or more instructions for the second processing system 220 are stored in one or more memory units (e.g., one or more portions of memory unit 115 (FIG. 1). In some such embodiments, it may be desirable to reduce the amount of memory that may be needed to store one or more of such instructions.

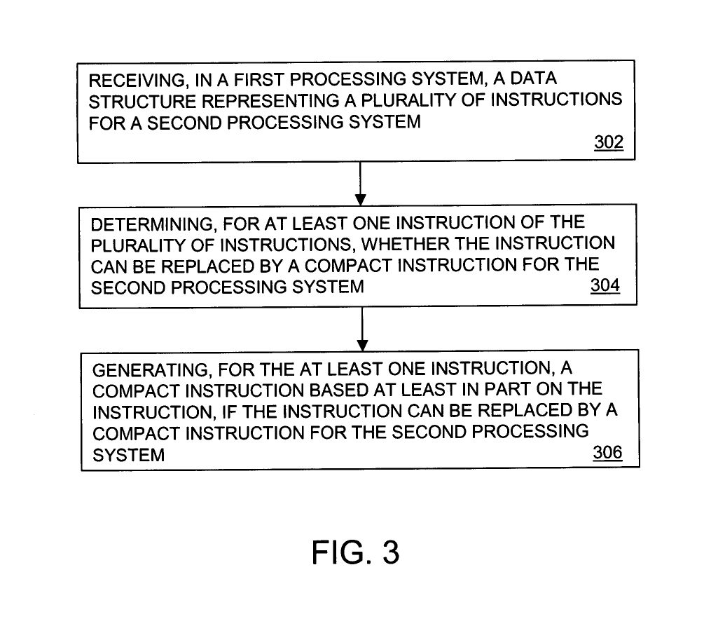

FIG. 3 is a flow chart of a method according to some embodiments. The flow charts described herein do not necessarily imply a fixed order to the actions, and embodiments may be performed in any order that is practicable. Note that any of the methods described herein may be performed by hardware, software (including microcode), firmware, or any combination of these approaches. For example, a hardware instruction mapping engine might be used to facilitate operation according to any of the embodiments described herein.

At 302, a data structure is received in a first processing system. The data structure represents a plurality of instructions for a second processing system. The first processing system may be, for example, an assembler, a compiler and/or a combination thereof. The plurality of instructions might be, for example, a plurality of machine code instructions to be executed by an execution engine of the second processing system. The plurality of instructions may include more than one type of instruction.

At 304, it is determined, for at least one of the plurality of instructions, whether the instruction can be replaced by a compact instruction (e.g., an instruction that represents the instruction and is more compact than the instruction) for the second processing system. According to some embodiments, a criterion is employed in determining whether the instruction can be replaced by a compact instruction. In such embodiments, determining whether the instruction can be replaced by a compact instruction may include determining whether the instruction satisfies the criterion. At 306, if the instruction can be replaced by a compact instruction, a compact instruction is generated based at least in part on the instruction. The compact instruction may have a length that is less than a length of the instruction replaced by such compact instruction. Thus, in some embodiments, less memory may be needed to store the compact instruction. In some embodiments, the compact instruction may include a field indicating that the compact instruction is a compact instruction.

In some embodiments, it may be determined, for each of the plurality of instructions, whether the instruction can be replaced by a compact instruction (e.g., an instruction that represents the instruction and is more compact than the instruction) for the second processing system. In some such embodiments, if the instruction can be replaced by a compact instruction, a compact instruction is generated based at least in part on the instruction.

According to some embodiments, the method may further include replacing the instruction with the compact instruction. For example, the instruction may be removed from the data structure and the compact instruction may be added to the data structure. The position of the compact instruction might be the same as the position at which the instruction resided, prior to removal of such instruction.

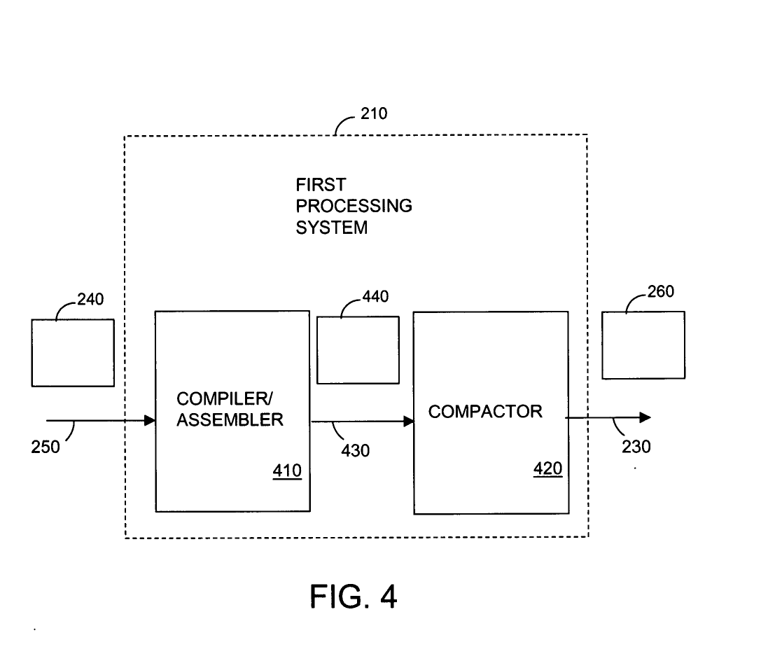

FIG. 4 is a block diagram of the first processing system 210 in accordance with some embodiments. Referring to FIG. 4, in some embodiments, the first processing system 210 includes a compiler and/or assembler 410 and a compactor 420. The compiler and/or assembler 410 and the compactor 420 may be coupled to one another, for example, via a communication link 430.

In some embodiments, the first processing system 210 may receive the first data structure 240 through the communication link 250. As stated above, the first data structure 240 may include, but is not limited to, a first plurality of instructions, which may include instructions in a first language, e.g., a high level language or an assembly language.

The first data structure 240 may be supplied to an input of the compiler and/or assembler 410. The compiler and/or assembler 410 includes a compiler, an assembler, and/or a combination thereof, that compiles and/or assembles one or more parts of the first data structure 240 in accordance with one or more requirements associated with the second processing system 220.

The compiler and/or assembler 410 may generate a data structure indicated at 440. The data structure 440 may include, but is not limited to, a plurality of instructions, which may include instructions in a second language, e.g., a machine language. In some embodiments, the plurality of instructions may be a plurality of machine code instructions to be executed by an execution engine of the second processing system 220. In some embodiments, the plurality of instructions may include more than one type of instruction.

The data structure 440 may be supplied to an input of the compactor 420, which may process each instruction in the data structure 440 to determine whether such instruction can be replaced by a compact instruction for the second processing system 220. If the instruction can be replaced, the compactor 420 may generate a compact instruction to replace such instruction. In some embodiments, the compactor 420 generates the compact instruction based at least in part on the instruction to be replaced. In some embodiments, the compact instruction includes a field indicating that the compact instruction is a compact instruction.

In accordance with some embodiments, the compactor 420 may replace the instruction with the compact instruction. In that regard, the plurality of instructions may represent a sequence of instructions. The instruction may be removed from its position in the sequence and the compact instruction may be inserted at such position in the sequence such that the position of the compact instruction in the sequence is the same as the position of the instruction replaced thereby, prior to removal of such instruction from the sequence.

In some embodiments, the position of each instruction within a sequence of instructions may be defined in any of various ways, for example, but not limited to, by a physical ordering of the instructions, by use of pointers that define the position or ordering of the instructions in the sequence, or any combination thereof. An instruction may be removed from a sequence by, for example, but not limited to, physically removing the instruction from a physical ordering, by updating any pointer(s) that may define the position or ordering, by creating another data structure that includes the sequence of instructions less the instruction being removed, or any combination thereof. An instructions may be added to a sequence by, for example, but not limited to, physically adding the instruction to a physical ordering, by updating any pointer(s) that may define the position or ordering, by creating another data structure that includes the sequence of instructions plus the instruction being added, or any combination thereof.

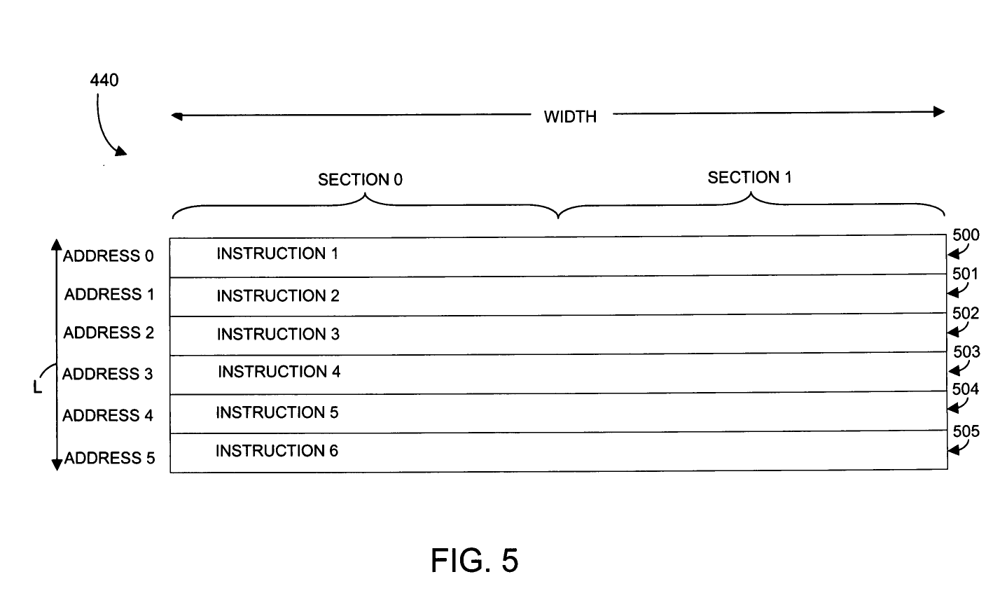

FIG. 5 is a block diagram representation of the data structure 440 generated by the compiler and/or assembler 410 according to some embodiments. Referring to FIG. 5, in some embodiments, the data structure 440 may include a plurality of instructions, e.g., instruction 1 through instruction 6. The data structure may further include a plurality of locations, e.g., location 500 through location 505, as well as a plurality of addresses, e.g., address 0-address 5, associated therewith. Each of the locations may include one or more bits. Each of the plurality of instruction may be stored at a respective location in the data structure. For example, instruction 1 through instruction 6 may be stored at locations 500 through 505, respectively.

The data structure may further have a length and a width. The length may indicate the number of locations and/or addresses in the data structure. The width may indicate the number of bits provided at each location and/or address in the data structure. In some embodiments, each location may include one or more sections, e.g., section 0 through section 1.

In some embodiments, each of the plurality of instructions has the same length as one another, which may or may not be equal to the width of the data structure. In some embodiments, one or more of the plurality of instructions may have a length that is different than the length of one or more other instructions of such plurality of instructions.

The plurality of instructions may define a sequence or sequence of instructions, e.g., instruction 1, instruction 2, instruction 3, instruction 4, instruction 5, instruction 6. Each instruction in the sequence of instructions may be disposed at a respective position in the sequence, e.g., instruction 1 may be disposed at a first position in the sequence, instruction 2 may be disposed at a second position in the sequence, instruction 3 may be disposed at a third position in the sequence, and so on.

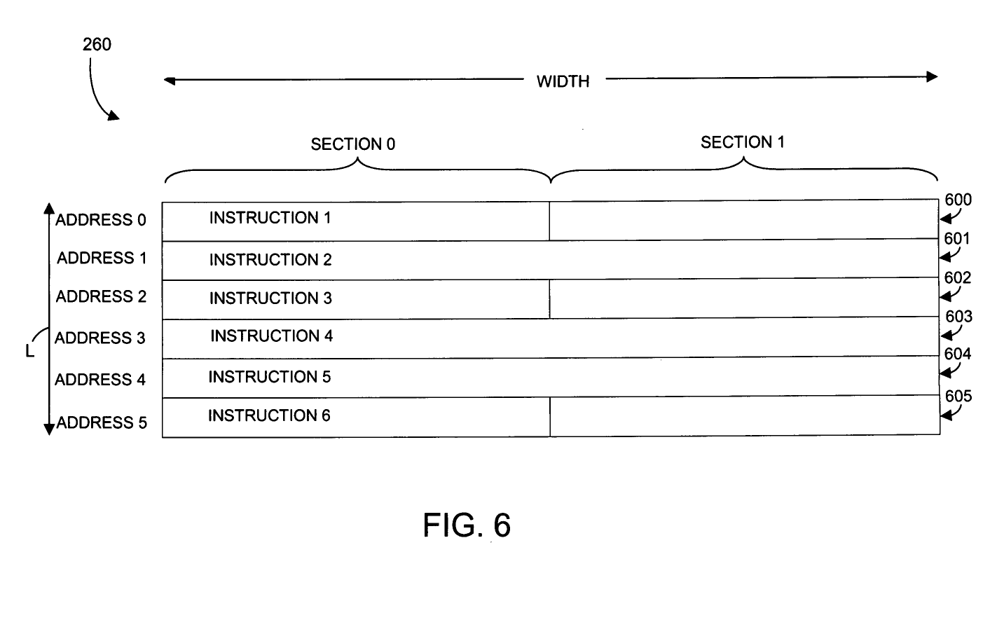

FIG. 6 is a block diagram representation of the data structure 260 generated by the compactor 420, according to some embodiments. Referring to FIG. 6, in some embodiments, the data structure 260 may be based at least in part on the data structure 440. The data structure 260 may include a plurality of instructions, e.g., instruction 1 through instruction 6. The data structure 260 may further include a plurality of locations, e.g., location 600 through location 605, as well as a plurality of addresses, e.g., address 0-address 5, associated therewith. Each of the plurality of instruction may be stored at a respective location in the data structure. For example, instruction 1 through instruction 6 may be stored at locations 600 through 605, respectively.

The data structure may further have a length and a width. The length may indicate the number of locations and/or addresses in the data structure. The width may indicate the number of bits provided at each location and/or address in the data structure. In some embodiments, each location may include one or more sections, e.g., section 0 through section 1.

One or more of the plurality of instructions may be a compact instruction. In the illustrated embodiment, for example, instruction 1, instruction 3 and instruction 6 are compact instructions that have replaced instruction 1, instruction 3 and instruction 6, respectively, of the data structure 440 (FIG. 5). Instruction 2, instruction 4 and instruction 5 are not compact instructions and are the same as or similar to instruction 2, instruction 4 and instruction 5, respectively, of the data structure 440 (FIG. 5).

Each compact instruction, e.g., instruction 1, instruction 3 and instruction 6, may have a length that is less than that of the non-compact instruction replaced by such compact instruction. In some embodiments, each of the compact instructions has the same length as one another. In some embodiments, one or more of the compact instructions has a length equal to one half the width of the data structure. In the illustrated embodiment, for example, each of the compact instructions has a length equal to one half the width of the data structure 260. However, compact instructions may or may not have the same length as one another. In some embodiments, one or more of the compact instructions has a length that is different than the length of one or more other compact instructions. Moreover, in some embodiments, one or more of the compact instructions has a length that is not equal to one half the width of the data structure.

The plurality of instructions may define a sequence or sequence of instructions, e.g., instruction 1, instruction 2, instruction 3, instruction 4, instruction 5, instruction 6, instruction 7, instruction 8. Each instruction in the sequence of instructions may be disposed at a respective position in the sequence, e.g., instruction 1 may be disposed at a first position in the sequence, instruction 2 may be disposed at a second position in the sequence, instruction 3 may be disposed at a third position in the sequence, and so on.

In some embodiments, the position of each instruction, e.g., instruction 1 through instruction 6, in the sequence of instructions is the same as the position of the corresponding instruction, e.g., instruction 1 through instruction 6, respectively, in the data structure 440 (FIG. 5). For example, instruction 1 of the data structure 260 and instruction 1 of the data structure 440 (FIG. 5) are each disposed at a first position in a sequence of instructions. Instruction 2 of the data structure 260 and instruction 2 of the data structure 440 (FIG. 5) are each disposed at a second position in a sequence of instructions. Instruction 3 of the data structure 260 and instruction 3 of the data structure 440 (FIG. 5) are each disposed at a third position in a sequence of instructions. And so on.

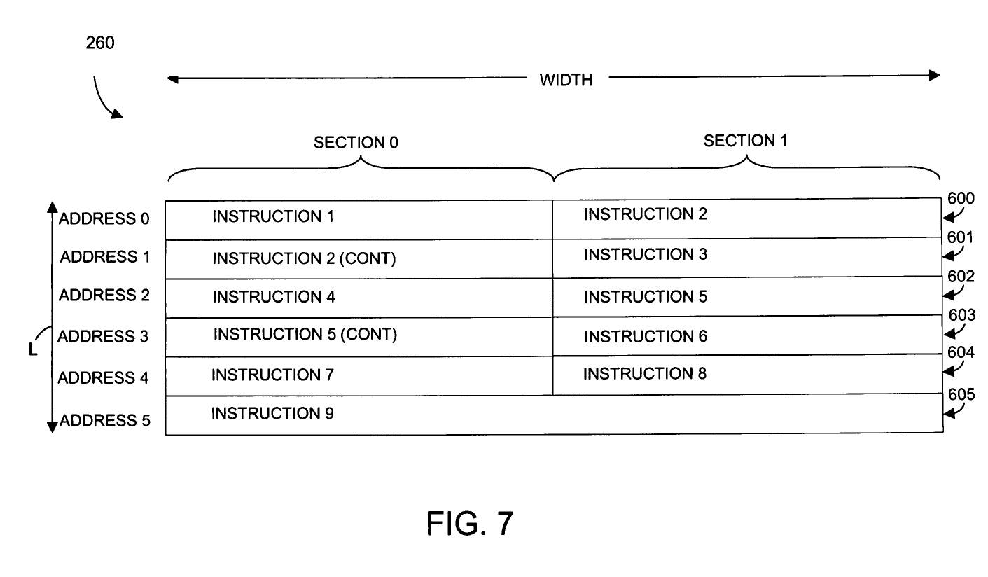

FIG. 7 is a block diagram representation of the data structure 260 generated by the compactor 420, according to some embodiments. Referring to FIG. 7, in some embodiments, more than one instruction may be stored in a single location of the data structure 260. Moreover, in some embodiments, one or more instructions may be wrapped from one location to another location. For example, instruction 1 may be stored in section 0 of location 600. Instruction 2 may be partitioned into two parts. One part of instruction 2 may be stored in section 1 of location 600. The other part of instruction 2 may be stored in section 0 of location 601 (sometimes referred to herein as wrapped). Instruction 3 may be stored in section 1 of location 601. Instruction 4 may be stored in section 0 of location 602. Instruction 5, may be partitioned into two parts. One part of instruction 5 may be stored in section 1 of location 602. The other part of instruction 5 may be stored in section 0 of location 603 (sometimes referred to herein as wrapped). Instruction 6 may be stored in section 1 of location 603.

Thus, the data structure 260 may be able to store additional instructions, e.g., instruction 7 through instruction 9. For example, instruction 7, which may be a compact instruction, may be stored in section 0 of location 604. Instruction 8, which may be a compact instruction, may be stored in section 1 of location 604. Instruction 9 may be stored in section 0 and section 1 of location 605.

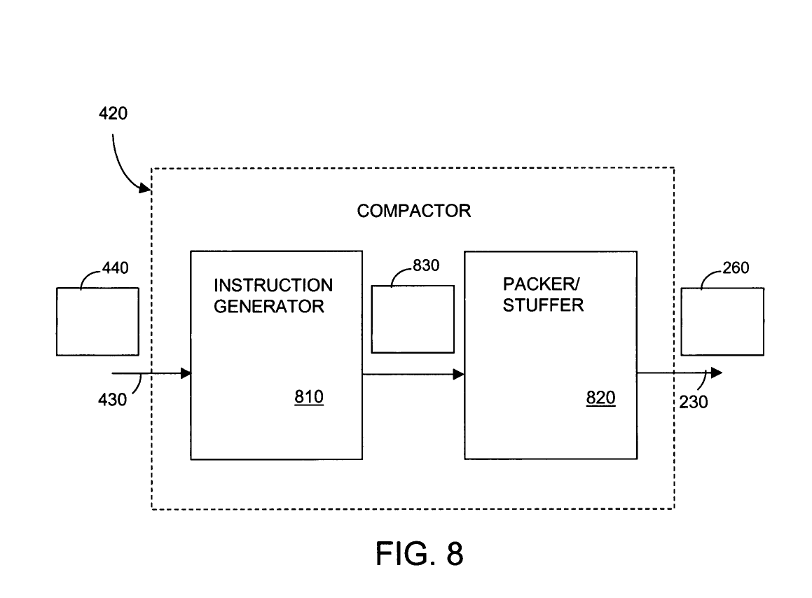

FIG. 8 is a block diagram of the compactor 420 according to some embodiments. Referring to FIG. 8, in some embodiments, the compactor 420 comprises an instruction generator 810 and a packer and/or stuffer 820. In some embodiments, the compactor 420 may receive the data structure 440 supplied by the compiler and/or assembler 410. The data structure 440 may be supplied to an input of the instruction generator 810, an output of which may supply a data structure 830. In some embodiments, the data structure 830 may be the same as or similar to the data structure 440 illustrated in FIG. 5. The data structure 830 may be supplied to an input of the packer and/or stuffer 820, an output of which may supply the data structure 260. In some embodiments, the packer and/or stuffer 820 provides packing and/or stuffing of such that the data structure 260 has a configuration that is the same as or similar to the data structure 260 illustrated in FIGS.

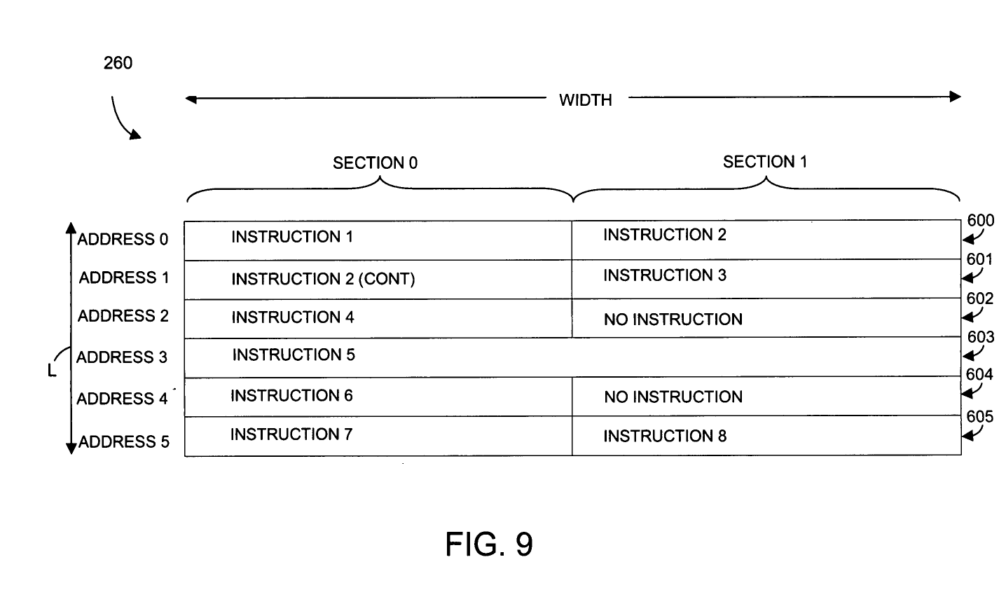

FIG. 9 is a block diagram representation of the data structure 260 generated by the compactor 420, according to some embodiments. Referring to FIG. 9, in some embodiments, there may be restrictions regarding the positioning of one or more types of instructions relative to the one or more locations in which such instructions are stored, sometimes referred to herein as alignment requirements. In some such embodiments, there may be a requirement that one or more types of instructions be aligned with the location(s) in which such instructions are stored. For example, it may be desired to store the first bit of such instructions in the first bit of a location). Some embodiments may have such requirements for branch instructions (targeted or not targeted) and/or for any type of instructions having a length equal to the width of the data structure 260. In some embodiments, such requirements are intended to help reduce the need for additional complexity within the second processing system 220, which may store, decode and/or execute the instructions. For example, and in view thereof, it may be desired to store the first bit of instruction 5 in the first bit of a location (sometimes referred to herein as aligning the instruction with the location). Similarly, it may be desired to store the first bit of instruction 7 in the first bit of a location.

In that regard, instruction 1 may be stored in section 0 of location 600. Instruction 2 may be partitioned into two parts. One part of instruction 2 may be stored in section 1 of location 600. The other part of instruction 2 may be stored in section 0 of location 601. Instruction 3 may be stored in section 1 of location 601. Instruction 4 may be stored in section 0 of location 602. Instruction 5 may be stored in section 0 and section 1 of location 603. Instruction 6 may be stored in section 0 of location 604. Instruction 7 may be stored in section 0 of location 605. Instruction 8 may be stored in section 1 of location 605.

In some such embodiments, one or more sections of the data structure 260 may have no instruction. For example, because it is desired to store the first bit of instruction 5 in the first bit of a location, there may not be an instruction stored in section 1 of location 602. Similarly, because it is desired to store the first bit of instruction 7 in the first bit of a location, there may not be an instruction stored in section 1 of location 604.

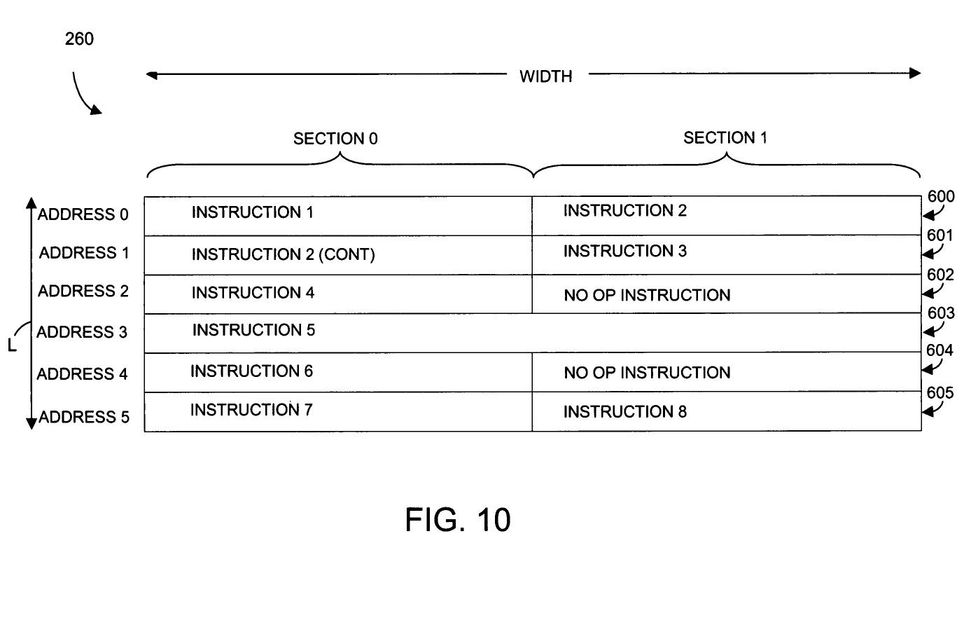

FIG. 10 is a block diagram representation of the data structure 260 generated by the compactor 420, according to some embodiments. Referring to FIG. 10, in some embodiments, a no op instruction is stored in one or more sections of the data structure so that such section(s) of the data structure are filled and/or not empty. For example, a no op instruction may be stored in section 1 of location 602. Similarly, a no op instruction may be stored in section 1 of location 604. As used herein, a no op instruction is an instruction that may be decoded and executed by the execution unit of the second processing system.

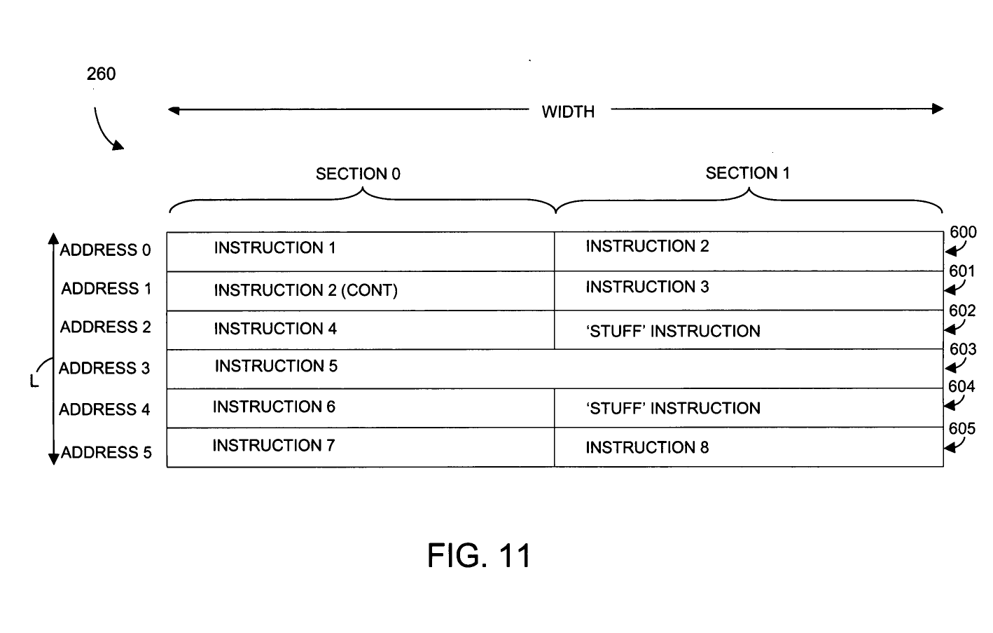

FIG. 11 is a block diagram representation of the data structure 260 generated by the compactor 420, according to some embodiments. Referring to FIG. 11, in some embodiments, it may be desirable to add a dummy instruction, sometimes referred to herein as a stuff instruction, rather than a no op instruction. As used herein, a stuff instruction is an instruction that is not decoded by the decoder and/or not executed by the execution unit of the second processing system.

For example, rather than having no instruction or a no op instruction stored in section 1 of location 602, a stuff instruction may be stored in section 1 of location 602. Similarly, rather than having no instruction stored in section 1 of location 604, a stuff instruction may be stored in section 1 of location 604. As used herein a stuff instruction is an instruction that will not be executed by the second processing system.

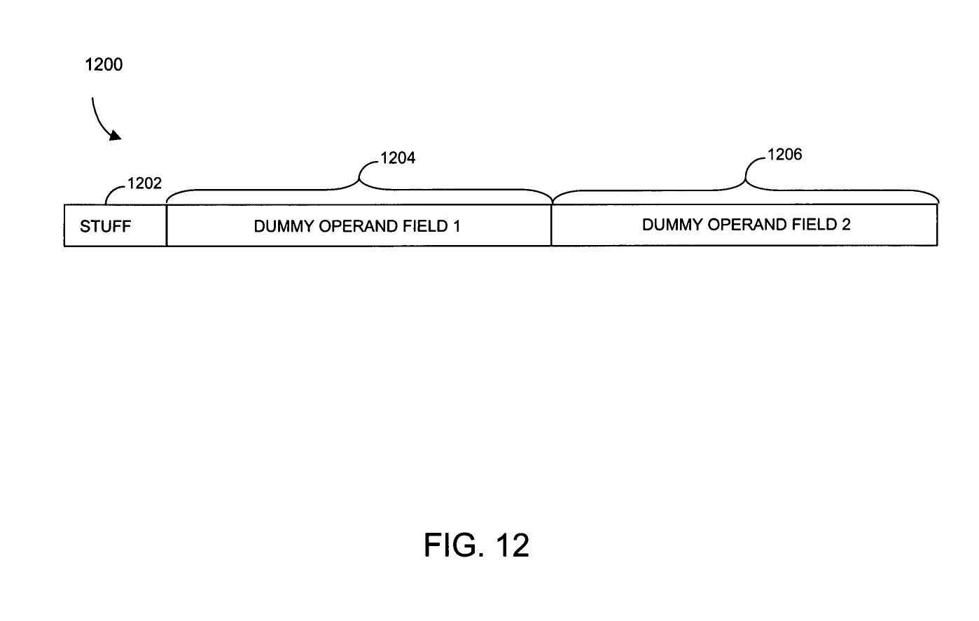

FIG. 12 shows an example of a stuff instruction format 1200 according to some embodiments. Referring to FIG. 12, the instruction format 1200 has an op code, e.g., STUFF, that identifies the instruction as a stuff instruction and is indicated at 1202. The instruction format may or may not have operands fields, e.g., dummy operand fields 1204, 1206.

An example of a stuff instruction that uses the instruction format of FIG. 12 is: STUFF.

In some embodiments, a stuff instruction is stored in one or more sections of the data structure such that such sections of the data structure are filled and/or not empty. In some embodiments, the availability of a stuff instruction may avoid the need for a no op instruction, which may thereby increase the speed and/or level of performance of a processor.

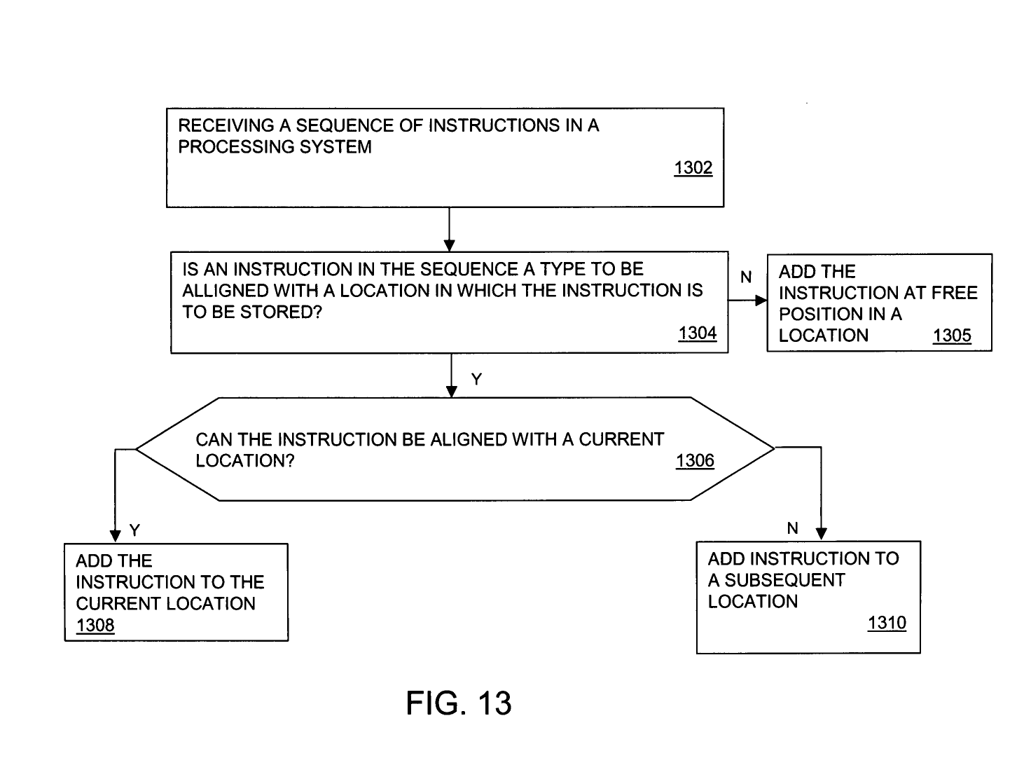

FIG. 13 is a flow chart of a method according to some embodiments. At 1302, a data structure is received in a first processing system. The first processing system may be, for example, an assembler, a compiler and/or a combination thereof. The data structure may represent a plurality of instructions for a second processing system. The plurality of instructions might be, for example, a plurality of machine code instructions to be executed by an execution engine of the second processing system. The plurality of instructions may include more than one type of instruction.

At 1304, it is determined, for each of the plurality of instructions, whether the instruction is a type of instruction to be aligned with a location in which the instruction is to be stored. According to some embodiments, a criterion is employed in determining whether the instruction is a type of instruction to be so aligned. In such embodiments, determining whether the instruction is a type of instruction to be so aligned may include determining whether the instruction satisfies the criterion.

At 1305, the instruction is added at a free position in a current location if the instruction is not a type of instruction to be so aligned.

At 1306, the method may further include determining if the instruction can be aligned in a current location. At 1308, the instruction is added to the current location if the instruction can be aligned therewith. At 1310, if the instruction cannot be aligned with the current location, the instruction is added to a subsequent location.

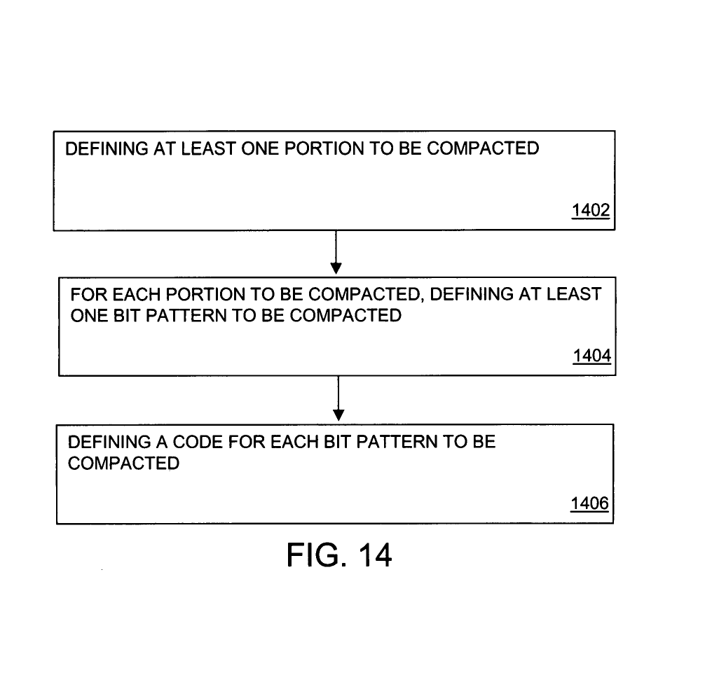

FIG. 14 is a flow chart of a method that may be used in defining compaction according to some embodiments. At 1402, the method may include identifying one or more portions, of one or more instructions, to compact. In some embodiments, one or more of the portions are identified by analyzing bit patterns of instructions in one or more sample programs. For example, instructions may be analyzed to identify one or more portions, of one or more instructions, having a high occurrence of one or more bit patterns. In some embodiments, such bit patterns may be any bit patterns. In some embodiments, the one or more portions represent less than all portions of the one or more instructions. In some embodiments, one or more of the one or more portions may include one or more op code fields, one or more source and/or destination fields and/or one or more immediate fields. In some embodiments, a compiler and/or assembler may be employed in identifying the one or more portions to compact.

At 1404 the method may further include identifying one or more bit patterns to compact in each of the one or more portions. In some such embodiments, four, eight, sixteen and/or some other number of bit patterns (but less than all patterns that occur) are identified to compact in each of the one or more portions. In some embodiments, one or more of the bit patterns to compact are identified by analyzing bit patterns of instructions in one or more sample programs. In some embodiments, a compiler and/or assembler may be employed in identifying the one or more bit patterns to compact in each portion to compact.

In one such embodiment, the eight most frequently occurring bit patterns are identified for each portion to be compacted, i.e., the eight most frequently occurring bit patterns for the first portion to compact, the eight most frequently occurring bit patterns for the second portion to compact, etc.

At 1406, each of the one or more bit patterns may be assigned a code (or compact bit code). If eight bit patterns are identified for a portion, the codes assigned to such bit patterns might have three bits. For example, a first bit pattern may be assigned a first code (e.g., “000”). A second bit pattern may be assigned a second code (e.g., “001”). A third bit pattern may be assigned a third code (e.g., bit code “010”). A fourth bit pattern may be assigned a fourth code (e.g., “011”). A fifth bit pattern may be assigned a fifth code (e.g., “100”). A sixth bit patterns may be assigned a sixth code (e.g., “101”). A seventh bit pattern may be assigned a seventh code (e.g., “110”). An eighth bit pattern may be assigned an eighth code (e.g., “111”).

In some embodiments, the one or more bit patterns may be stored in one or more tables. For example, a table may be generated for each portion to be compacted. Each table may store the one or more bit patterns to be compacted for that portion.

In some embodiments, the code assigned to a bit pattern may identify an address at which the bit pattern is to be stored in the table. The code may also be used as an index to retrieve the bit pattern from the table.

In some embodiments, the bit patterns may be assigned to the tables in a manner that helps to minimize loading on the memory. In some embodiments, for example, power consumption may be reduced by reducing the number of logic “1” bit states within a memory. Thus, in some embodiments, codes having the least number of logic “1” bit states may be assigned to those bit patterns that occur most frequently in the instructions.

In some embodiments, each portion may have any form. A portion may comprise one or more bits. The bits may or may not be adjacent to one another in the instruction. Portions may overlap or not overlap. Thus, although the portions may be shown as approximately equally sized and non-overlapping, there are no such requirements.

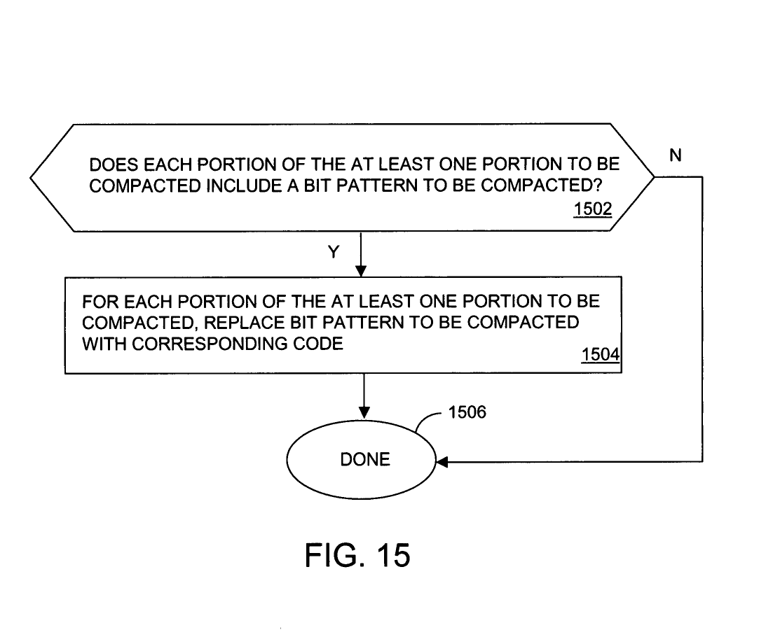

FIG. 15 is a flow chart of a method for determining whether an instruction can be replaced by a compact instruction, and if so, generating a compact instruction to replace the instruction, according to some embodiments. At 1502, a determination is made as to whether each of the at least one portions to be compacted includes a bit pattern to be compacted.

If so, at 1504, each bit pattern to be compacted in each portion to be compacted is replaced by a corresponding compact code. If any of the at least one portion to be compacted does not include a bit pattern to be compacted, then the instruction is not compacted and execution jumps to 1506.

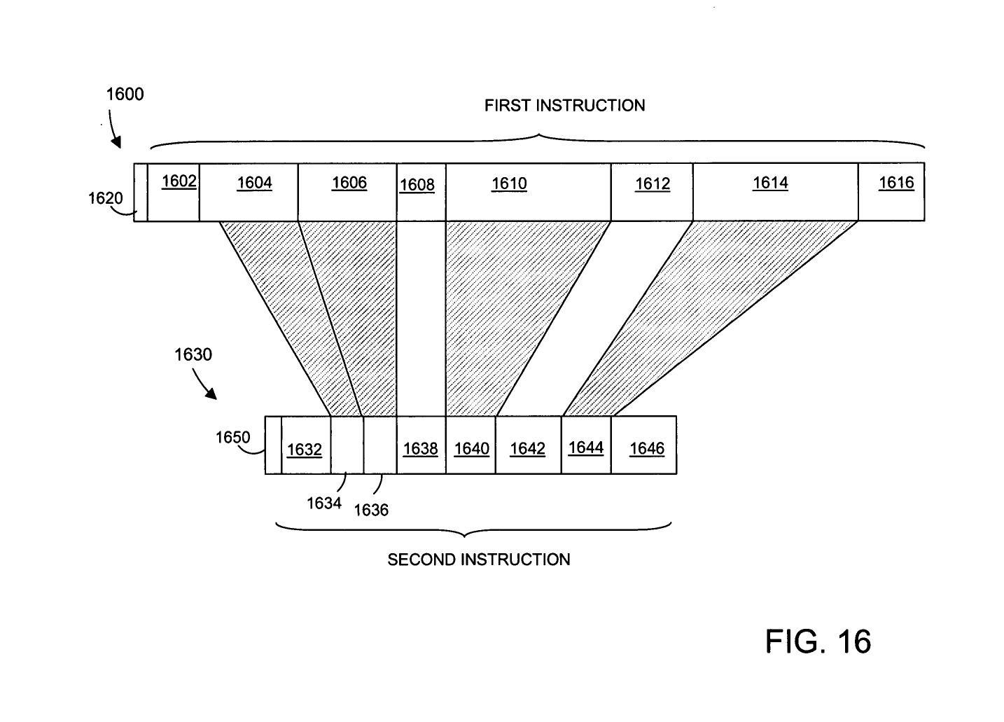

FIG. 16 is a schematic representation of compaction according to some embodiments. Referring to FIG. 16, in some embodiments, an instruction to be compacted includes one or more portions. For example, a first instruction 1600 may include a first portion 1602, a second portion 1604, a third portion 1606, a fourth portion 1608, a fifth portion, 1610, a sixth portion 1612, a seventh portion 1614 and an eighth portion 1616. Each portion may include one or more fields. For example, one portion, e.g., the first portion 1602, may include one or more fields that specify an op code. One portion, e.g., the second portion 1604, may include one or more fields that specify a plurality of control bits. One portion, e.g., the third portion 1606, may include one or more fields that specify a register and/or data types. One portion, e.g., the sixth portion 1612, may include one or more fields that specify a first source operand description. One portion, e.g., the eighth portion 1616, may include one or more fields that specify a second source operand description.

One or more portions of the first instruction may be portions to be compacted. In some embodiments, for example, the second portion 1634, the third portion 1636, the fifth portion 1640 and the seventh portion may be portions to be compacted. One or more other portions may not be portions to be compacted. For example, the first portion 1632, the fourth portion 1638, the sixth portion 1642 and the eighth portion 1646 may not be portions to be compacted.

A compact instruction may also include one or more portions. For example, a second instruction 1630 may include a first portion 1632, a second portion 1634, a third portion 1636, a fourth portion 1638, a fifth portion, 1640, a sixth portion 1642, a seventh portion 1644 and an eighth portion 1646.

One or more portions of the compact instruction may be compacted portions. For example, in some embodiments, the second portion 1634, the third portion 1636, the fifth portion 1640 and the seventh portion may be compacted portions. The first portion 1632, the fourth portion 1638, the sixth portion 1642 and the eighth portion 1646 may be noncompacted portions and may be the same as or similar to the first portion 1602, the fourth portion 1608, the sixth portion 1612 and the eighth portion 1616, respectively, of the first instruction 1600.

In some embodiments, the first instruction 1600 may include a field 1620 to indicate that the first instruction is not a compact instruction. In some embodiments, the second instruction 1630 may include a field 1650 to indicate that the second instruction is a compact instruction

The compact instruction may have fewer bits than the non-compact instruction. That is, the original instruction may have a first number of bits and the compact instruction may have a second number of bits less than the first number of bits. In some embodiments, the second number of bits is less than or equal to one half the first number of bits.

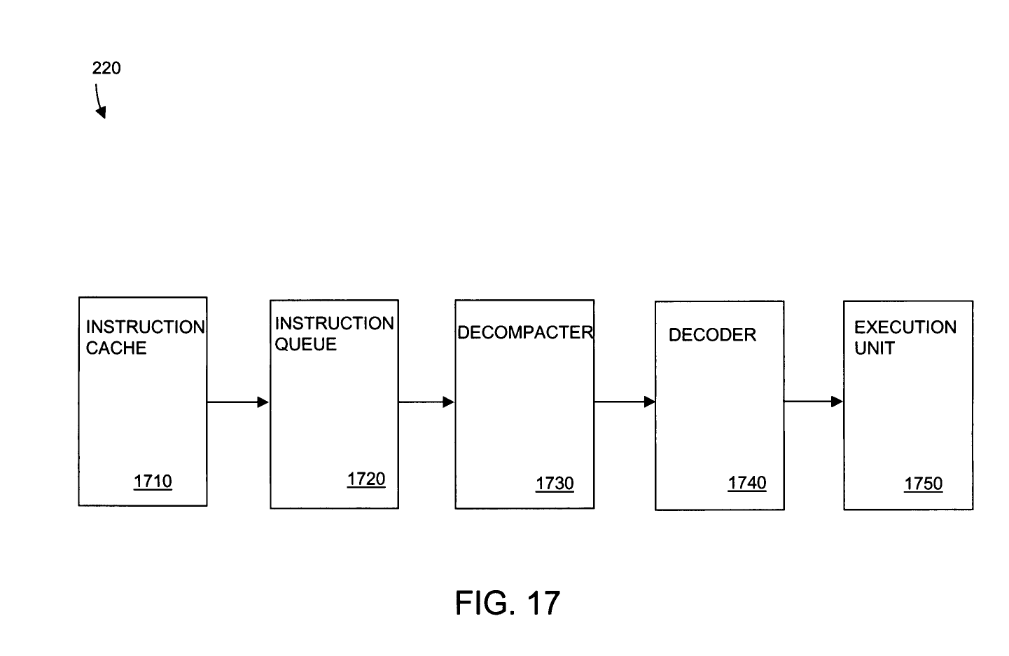

FIG. 17 is a block diagram of a portion of the second processing system 220, according to some embodiments. Referring to FIG. 17, in some embodiments, the second processing system may include an instruction cache (or other memory) 1710, an instruction queue 1720, a decompactor 1730, a decoder 1740 and an execution unit 1750.

The instruction cache (or other memory) 1710 may store a plurality of instructions, which may define one, some or all parts of one or more programs being executed and/or to be executed by the processing system. In some embodiments, the plurality of instructions may include, but is not limited to, one or more of the plurality of instructions represented by the data structure 260 (FIG. 2). Instructions may be fetched from the instruction cache (or other memory) 1710 and supplied to an input of the instruction queue 1720, which may be sized, for example, to store a small number of instructions, e.g., six to eight instructions.

An output of the instruction queue 1720 may supply an instruction, which may be supplied to the decompactor 1730. In accordance with some embodiments, the decompactor 1730 may determine whether the instruction is a compact instruction. One or more criteria may be employed in determining whether the instruction is a compact instruction. In some embodiments, a compact instruction includes a field indicating that the instruction is a compact instruction.

If the instruction is not a compact instruction, the instruction may be supplied to an input of the decoder 1740, which may decode the instruction to provide a decoded instruction. An output of the decoder 1740 may supply the decoded instruction to the execution unit 1750, which may execute the decoded instruction.

If the instruction is a compact instruction, the decompactor 1730 may generate a decompacted instruction, based at least in part on the compact instruction. The decompacted instruction may be supplied to the input of the decoder 1740, which may decode the decompacted instruction to generate a decoded instruction. The output of the decoder 1740 may supply the decoded instruction, which may be supplied to the execution unit 1750, which may execute the decoded instruction.

In some embodiments, if the decompacted instruction is a stuff instruction, such decompacted instruction may not be sent to the decoder and/or the execution unit.

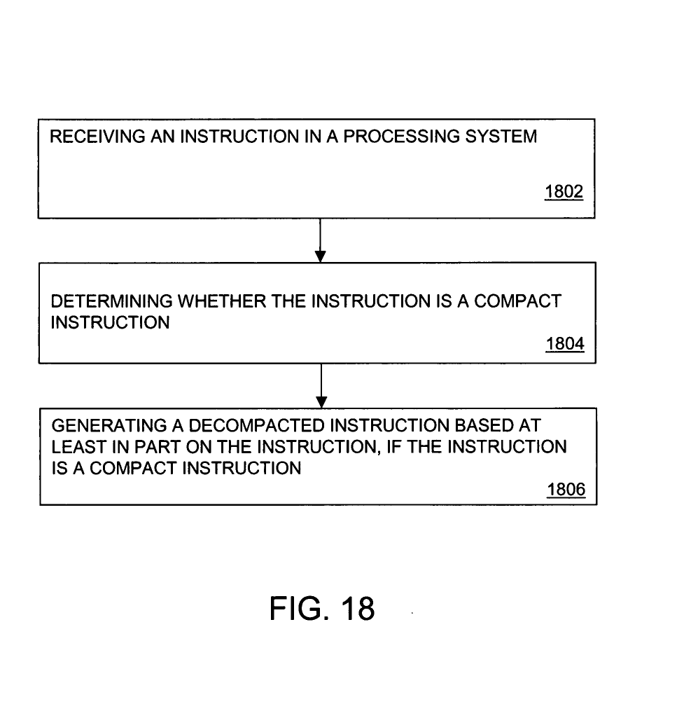

FIG. 18 is a flow chart of a method according to some embodiments. At 1802, an instruction is received in a processing system. The instruction may be, for example, a machine code instruction. According to some embodiments, the instruction is supplied to an execution engine of the processing system. In some such embodiments, the execution engine may have an instruction cache that receives the instruction.

In some embodiments, the processing system includes a SIMD execution engine. The instruction may be, for example, a machine code instruction to be executed by the SIMD execution engine. According to some embodiments, the instruction may specify one or more source operands and/or one or more destinations. The one or more of the source operands and/or one or more of the destinations might be, for example, encoded in the instruction. According to some embodiments, one or more of the plurality of instructions may have a format that is the same as or similar to one or more of the instructions described herein.

At 1804, it is determined whether the instruction is a compact instruction. One or more criteria may be employed in determining whether the instruction is a compact instruction. In some embodiments, a compact instruction includes a field indicating that the instruction is a compact instruction.

At 1806, if the instruction is a compact instruction, a decompacted instruction is generated based at least in part on the compact instruction.

In some embodiments, the method further includes replacing the compact instruction with the decompacted instruction if the instruction is a compact instruction. For example, the compact instruction may be removed from an instruction pipeline and the decompacted instruction may be added to the instruction pipeline. The position of the decompacted instruction may be the same as the position of the compact instruction prior to removal of such instruction.

According to some embodiments, the method may further include decoding the instruction to provide a decoded instruction if the instruction is not a compact instruction and decoding the decompacted instruction to provide a decoded instruction if the instruction is a compact instruction. In some embodiments, the method may further include executing the decompacted instruction and/or a decoded instruction.

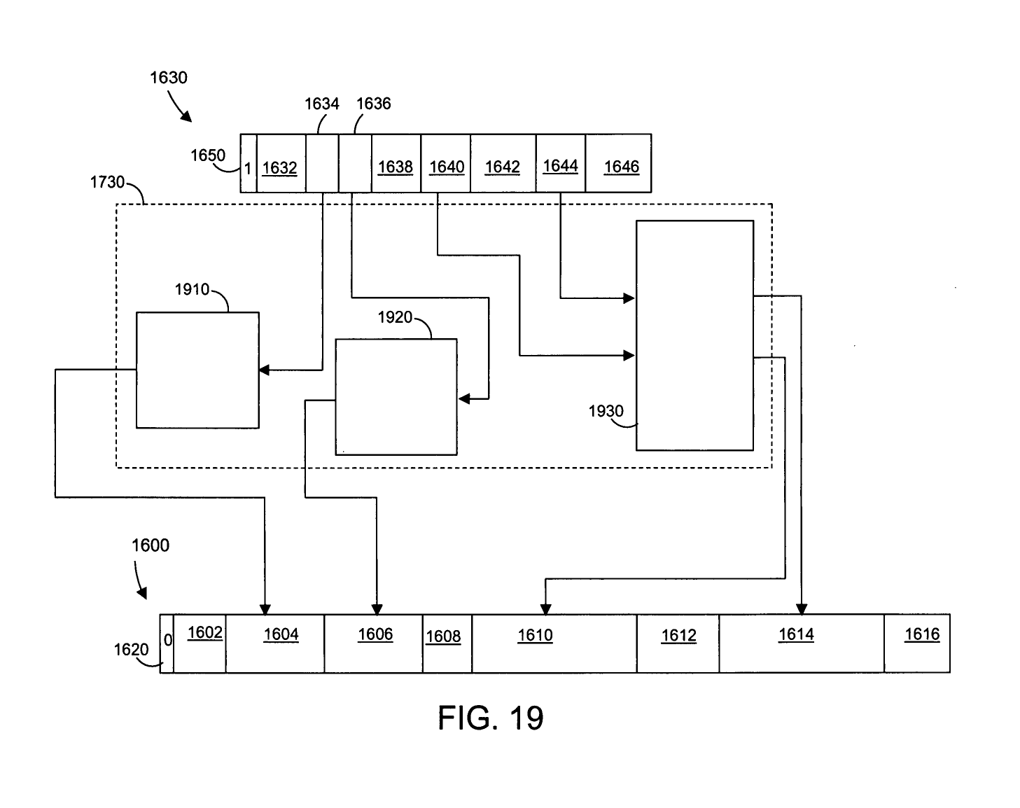

FIG. 19 is a schematic representation of a portion of the decompactor 1730 according to some embodiments. Referring to FIG. 19, in some embodiments, a compact instruction may include one or more portions. For example, the compact instruction 1630 may include a first portion 1632, a second portion 1634, a third portion 1636, a fourth portion 1638, a fifth portion, 1640, a sixth portion 1642, a seventh portion 1644, and an eighth portion 1646. One or more portions of a compact instruction may be compact portions.

One or more other portions of the compact instruction may be noncompacted portions. For example, the second portion 1634, the third portion 1636, the fifth portion 1640 and the seventh portion may be compacted portions. The first portion 1632, the fourth portion 1638, the sixth portion 1642 and the eighth portion 1646 may be noncompacted portions.

The decompacted instruction may also include one or more portions. For example, the decompacted instruction 1600 may include a first portion 1602, a second portion 1604, a third portion 1606, a fourth portion 1608, a fifth portion, 1610, a sixth portion 1612, a seventh portion 1614, and an eighth portion 1616.

One or more portions of the decompacted instruction 1600 may be decompacted portions. For example, in some embodiments, the second portion 1604, the third portion 1606, the fifth portion 1610 and the seventh portion may be decompacted portions.

In some embodiments, one of the compacted portions of the compacted instruction 1630, e.g., the second portion 1634, may be supplied to an input of a first portion 1910 of the decompactor 1730, which may decompact such compacted portion to provide the decompacted portion 1604 of decompacted instruction 1600. A second one of the compacted portions of the compacted instruction 1630, e.g., the third portion 1636, may be supplied to an input of a second portion 1920 of the decompactor 1730, which may decompact such compacted portion to provide the decompacted portion 1606 of the decompacted instruction 1600.

A third one of the compacted portions of the compacted instruction 1630, e.g., the fifth portion 1640, may be supplied to an input of a third portion 1930 of the decompactor 1730, which may decompact such compacted portion to provide the decompacted portion 1610 of decompacted instruction.

A fourth one of the compacted portions of the compacted instruction 1630, e.g., the seventh portion 1644, may also be supplied to an input of the third portion 1930 of the decompactor 1730, which may decompact such compacted portion to provide the decompacted portion 1614 of the decompacted instruction.

One or more other portions of the decompacted instruction 1600, e.g., the first portion 1602, the fourth portion 1608, the sixth portion 1612 and the eighth portion 1616 may be the same as or similar to the first portion 1632, the fourth portion 1638, the sixth portion 1642 and the eighth portion 1646, respectively, of the compact instruction 1630.

In some embodiments, the second portion 1604, the third portion 1606, the fifth portion 1610 and the seventh portion 1614 of the compact instruction 1630 each comprise three bits.

In some embodiments, the second portion 1604 and the third portion 1606 of the decompacted instruction 1600 each comprise a total of eighteen bits and the fifth portion 1610 and the seventh portion 1614 of the decompacted instruction 1600 each comprise a total of twelve bits.

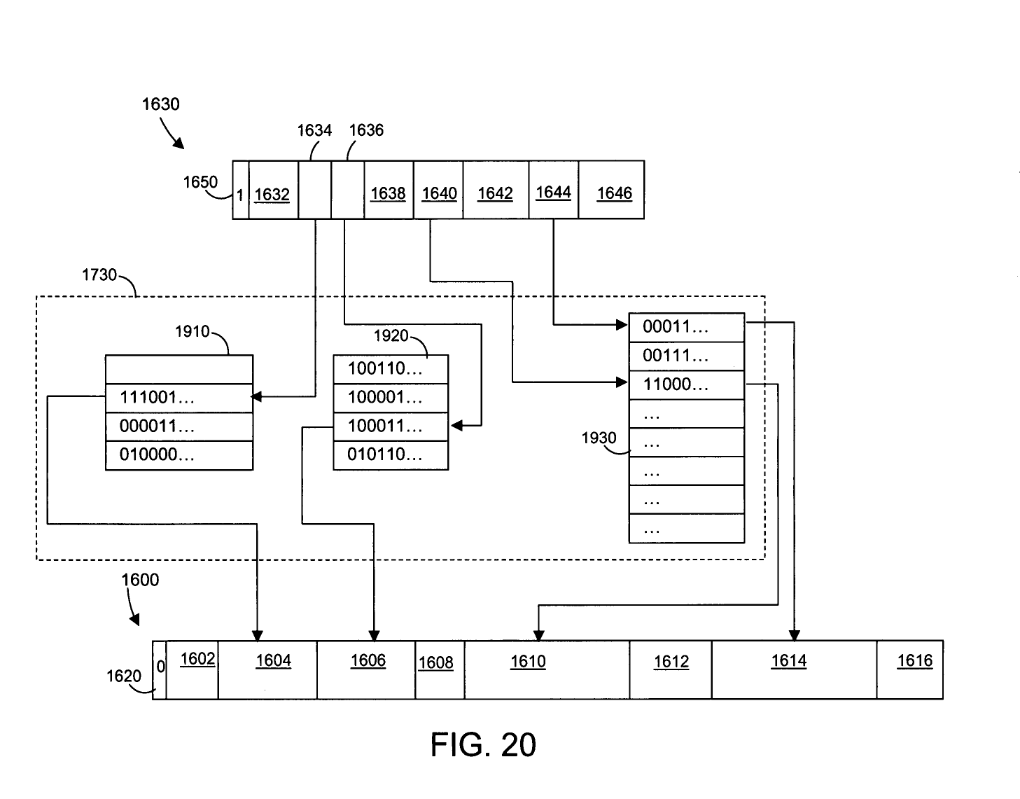

FIG. 20 is a schematic representation of a portion of the decompactor 1730 according to some embodiments. Referring to FIG. 20, in some embodiments, the first, second and third portions 1910, 1920, 1930 of the decompactor 1730 may each comprise a look-up table. Each look-up table may store one or more bit patterns. For example, the look-up table for the first portion 1910 of the decompactor 1730 may include the one or more bit patterns compacted for the second portion 1604 of the decompacted instruction 1600. The look-up table for the second portion 1920 of the decompactor 1730 may include the one or more bit patterns compacted for the third portion 1606 of the decompacted instruction 1600. The look-up table for the third portion 1930 of the decompactor 1730 may include the one or more bit patterns compacted for the fifth portion 1610 and the seventh portion 1614 of the decompacted instruction 1600.

In some embodiments, each of the compacted portions may define a code that may be used as an index to retrieve the appropriate bit pattern from the associated table. For example, the code may define an address (in the associated table) at which the bit pattern corresponding to the code is stored.

For example, the second portion 1634 of the compacted instruction 1630 may define a first code that may be used as an index (e.g., an address in the look-up table storing bit patterns associated with the second portion 1634) to retrieve a bit pattern that defines the second portion 1604 of the decompacted instruction 1600. The third portion 1636 of the compacted instruction 1630 may define a second code that may be used as an index (e.g., an address in the look-up table storing bit patterns associated with the third portion 1636) to retrieve a bit pattern that defines the third portion 1604 of the decompacted instruction 1600. The fifth portion 1640 of the compacted instruction 1630 may define a third code that may be used as an index (e.g., an address in the look-up table storing bit patterns associated with the fifth portion 1640) to retrieve a bit pattern that defines the fifth portion 1610 of the decompacted instruction 1600. The seventh portion 1644 of the compacted instruction 1630 may define a fourth code that may be used as an index (e.g., an address in the look-up table storing bit patterns associated with the seventh portion 1644) to retrieve a bit pattern that defines the seventh portion 1614 of the decompacted instruction 1600.

Although four compacted portions and three look-up tables are shown, other embodiments may also be employed.

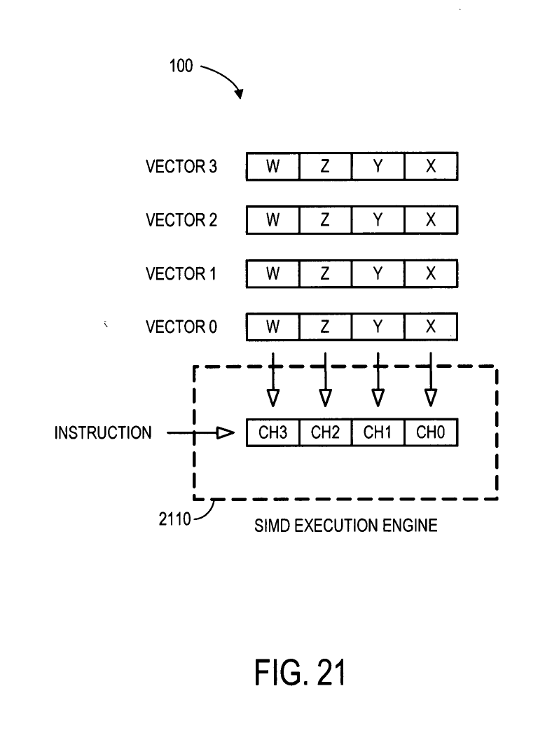

In some embodiments, the second processing system 220 may include one or more processing systems that include an SIMD execution engine, for example as illustrated in FIGS. 21-33. In some embodiments, one or more methods, apparatus and/or systems disclosed herein are employed in processing systems that include an SIMD execution engine, for example as illustrated in FIGS. 21-33. FIG. 21 illustrates one type of processing system 2100 that may be used in the second processing system 220 (FIG. 2) according to some embodiments. The processing system 2100 includes a SIMD execution engine 2110. In this case, the execution engine 2110 receives an instruction (e.g., from an instruction memory unit) along with a four-component data vector (e.g., vector components X, Y, Z, and W, each having bits, laid out for processing on corresponding channels 0 through 3 of the SIMD execution engine 2110). The engine 2110 may then simultaneously execute the instruction for all of the components in the vector. Such an approach is called a “horizontal,” “channel-parallel,” or “Array Of Structures (AOS)” implementation.

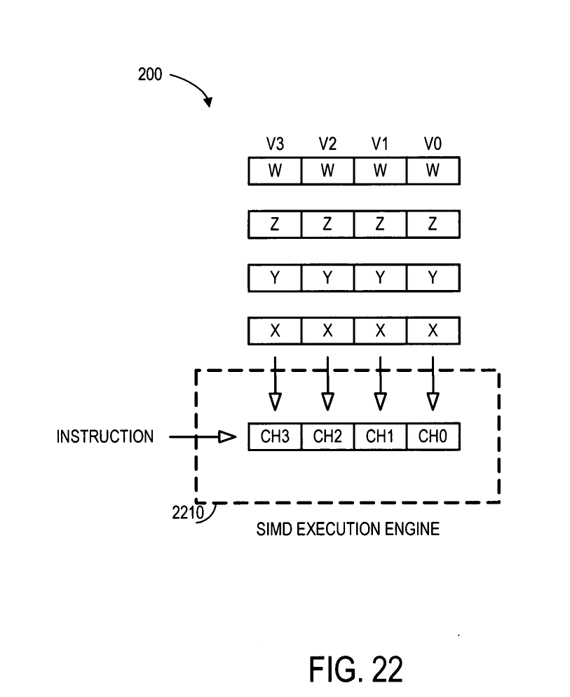

FIG. 22 illustrates another type of processing system 2200 that includes a SIMD execution engine 2210. In this case, the execution engine 2210 receives an instruction along with four operands of data, where each operand is associated with a different vector (e.g., the four X components from vectors V0 through V3). Each vector may include, for example, three location values (e.g., X, Y, and Z) associated with a three-dimensional graphics location. The engine 2210 may then simultaneously execute the instruction for all of the operands in a single instruction period. Such an approach is called a “vertical,” “channel-serial,” or “Structure Of Arrays (SOA)” implementation. Although some embodiments described herein are associated with a four and eight channel SIMD execution engines, note that a SIMD execution engine could have any number of channels more than one (e.g., embodiments might be associated with a thirty-two channel execution engine).

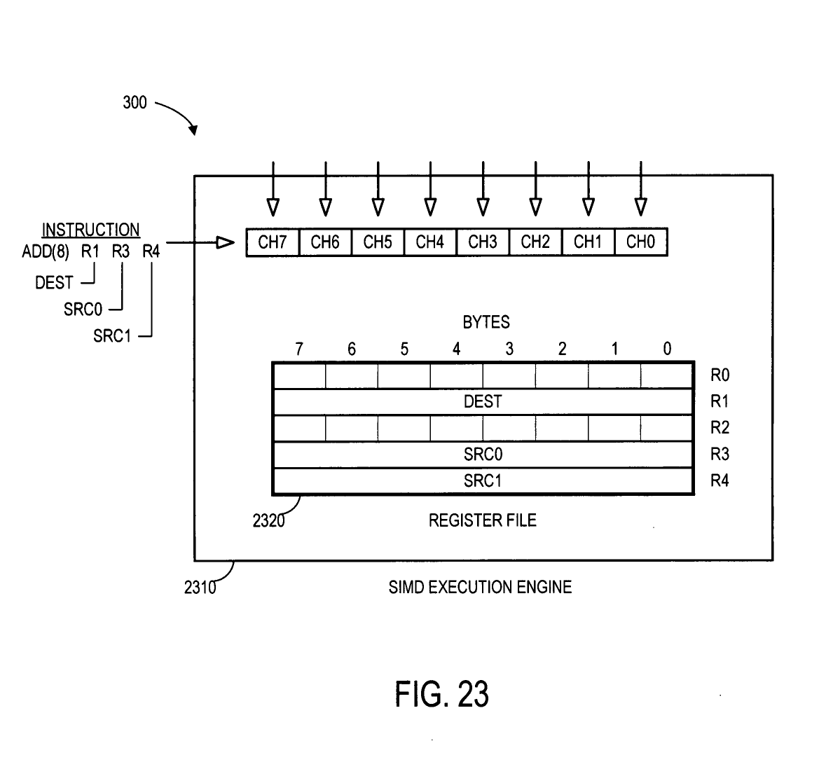

FIG. 23 illustrates a processing system 2300 with an eight-channel SIMD execution engine 2310. The execution engine 310 may include an eight-byte register file 2320, such as an on-chip General Register File (GRF), that can be accessed using assembly language and/or machine code instructions. In particular, the register file 2320 in FIG. 23 includes five registers (R0 through R4) and the execution engine 2310 is executing the following hardware instruction:
add(8) R1 R3 R4
   The “(8)” indicates that the instruction will be executed on operands for all eight execution channels. The “R1” is a destination operand (DEST), and “R3” and “R4” are source operands (SRC0 and SRC1, respectively). Thus, each of the eight single-byte data elements in R4 will be added to corresponding data elements in R3. The eight results are then stored in R1. In particular, the first byte of R4 will be added to the first byte of R3 and that result will be stored in the first byte of R1. Similarly, the second byte of R4 will be added to the second byte of R3 and that result will be stored in the second byte of R1, etc.

In some applications, it may be helpful to access information in a register file in various ways. For example, in a graphics application it might at some times be helpful to treat portions of the register file as a vector, a scalar, and/or an array of values. Such an approach may help reduce the amount of instruction and/or data moving, packing, unpacking, and/or shuffling and improve the performance of the system.

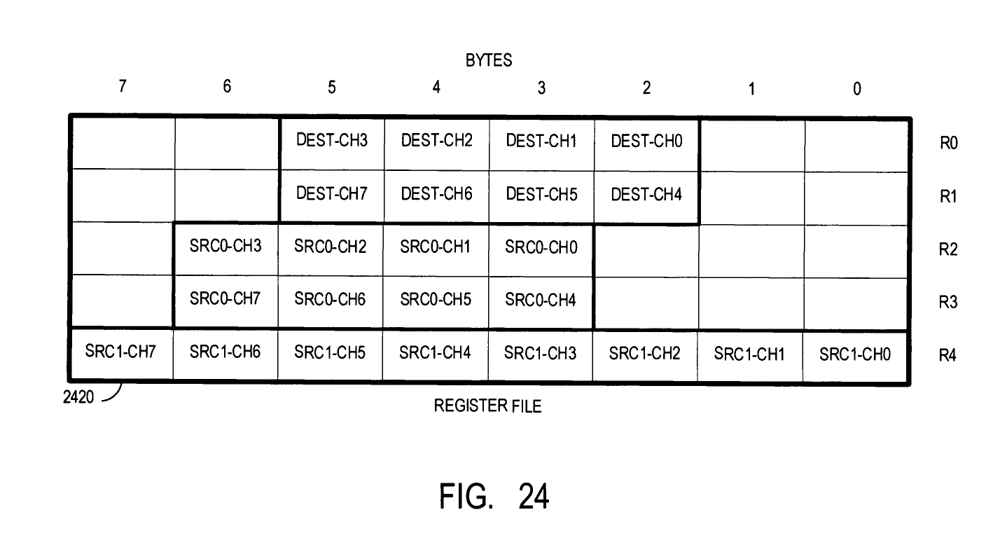

FIG. 24 illustrates a processing system 2400 with an eight-channel SIMD execution engine 2410 according to some embodiments. In this example, three regions have been described for a register file 2420 having five eight-byte registers (R0 through R4): a destination region (DEST) and two source regions (SRC0 and SRC1). The regions might have been defined, for example, by a machine code add instruction. Moreover, in this example all execution channels are being used and the data elements are assumed to be bytes of data (e.g., each of eight SRC1 bytes will be added to a corresponding SRC0 byte and the results will be stored in eight DEST bytes in the register file 2420).

Each region description includes a register identifier and a “sub-register identifier” indicating a location of a first data element in the register file 2420 (illustrated in FIG. 24 as an “origin” of RegNum.SubRegNum). The sub-register identifier might indicate, for example, an offset from the start of a register (e.g., and may be expressed using a physical number of bits or bytes or a number of data elements). For example, the DEST region in FIG. 24 has an origin of R0.2, indicating that first data element in the DEST region is located at byte two of the first register (R0). Similarly, the SRC0 region begins at byte three of R2 (R2.3) and the SCR1 region starts at the first byte of R4 (R4.0). Note that the described regions might not be aligned to the register file 2420 (e.g., a region does not need to start at byte 0 and end at byte 7 of a single register).

Note that an origin might be defined in other ways. For example, the register file 2420 may be considered as a contiguous 40-byte memory area. Moreover, a single 6-bit address origin could point to a byte within the register file 2420. Note that a single 6-bit address origin is able to point to any byte within a register file of up to 64-byte memory area. As another example, the register file 2420 might be considered as a contiguous 320-bit memory area. In this case, a single 9-bit address origin could point to a bit within the register file 2420.

Each region description may further include a “width” of the region. The width might indicate, for example, a number of data elements associated with the described region within a register row. For example, the DEST region illustrated in FIG. 24 has a width of four data elements (e.g., four bytes). Since eight execution channels are being used (and, therefore eight one-byte results need to be stored), the “height” of the region is two data elements (e.g., the region will span two different registers). That is, the total number of data elements in the four-element wide, two-element high DEST region will be eight. The DEST region might be considered a two dimensional array of data elements including register rows and register columns.

Similarly, the SRC0 region is described as being four bytes wide (and therefore two rows or registers high) and the SRC1 region is described as being eight bytes wide (and therefore has a vertical height of one data element). Note that a single region may span different registers in the register file 520 (e.g., some of the DEST region illustrated in FIG. 24 is located in a portion of R0 and the rest is located in a portion of R1).

Although some embodiments discussed herein describe a width of a region, according to other embodiments a vertical height of the region is instead described (in which case the width of the region may be inferred based on the total number of data elements). Moreover, note that overlapping register regions may be defined in the register file 2420 (e.g., the region defined by SRC0 might partially or completely overlap the region defined by SRC1). In addition, although some examples discussed herein have two source operands and one destination operand, other types of instructions may be used. For example, an instruction might have one source operand and one destination operand, three source operands and two destination operands, etc.

According to some embodiment, a described region origin and width might result in a region “wrapping” to the next register in the register file 2420. For example, a region of byte-size data elements having an origin of R2.6 and a width of eight would include the last bytes of R2 along with the first six bytes of R3. Similarly, a region might wrap from the bottom of the register file 2420 to the top (e.g., from R4 to R0).

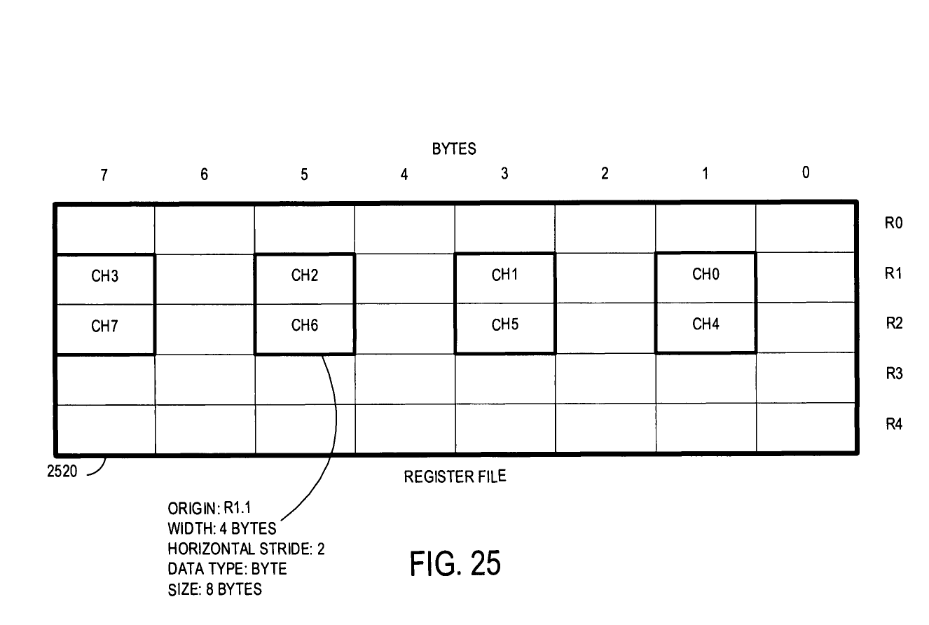

The SIMD execution engine may add each byte in the described SRC1 region to a corresponding byte in the described SRC0 region and store the results the described DEST region in the register file 2420. For example, FIG. 25 illustrates execution channel mapping in the register file 2520 according to some embodiments. In this case, data elements are arranged within a described region in a row-major order. Consider, for example, channel 6 of the execution engine. This channel will add the value stored in byte six of R4 to the value stored in byte five of R3 and store the result in byte four of R1. According to other embodiments, data elements may arranged within a described region in a column-major order or using any other mapping technique.

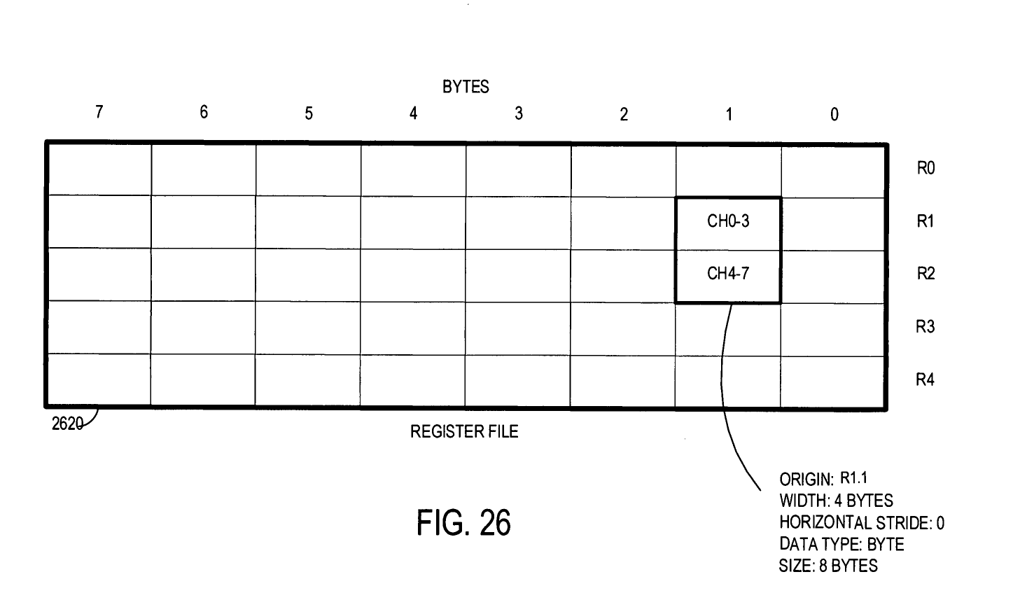

FIG. 26 illustrates a region description including a “horizontal stride” according to some embodiments. The horizontal stride may, for example, indicate a column offset between columns of data elements in a register file 2620. In particular, the region described in FIG. 26 is for eight single-byte data elements (e.g., the region might be appropriate when only eight channels of a sixteen-channel SIMD execution engine are being used by a machine code instruction). The region is four bytes wide, and therefore two data elements high (such that the region will include eight data elements) and beings at R1.1 (byte 1 of R1).

In this case, a horizontal stride of two has been described. As a result, each data element in a row is offset from its neighboring data element in that row by two bytes. For example, the data element associated with channel 5 of the execution engine is located at byte 3 of R2 and the data element associated with channel 6 is located at byte 5 of R2. In this way, a described region may not be contiguous in the register file 2620. Note that when a horizontal stride of one is described, the result would be a contiguous 4×2 array of bytes beginning at R1.1 in the two dimensional map of the register file 2620.

The region described in FIG. 26 might be associated with a source operand, in which case data may be gathered from the non-contiguous areas when an instruction is executed. The region described in FIG. 26 might also be associated with a destination operand, in which case results may be scattered to the non-contiguous areas when an instruction is executed.

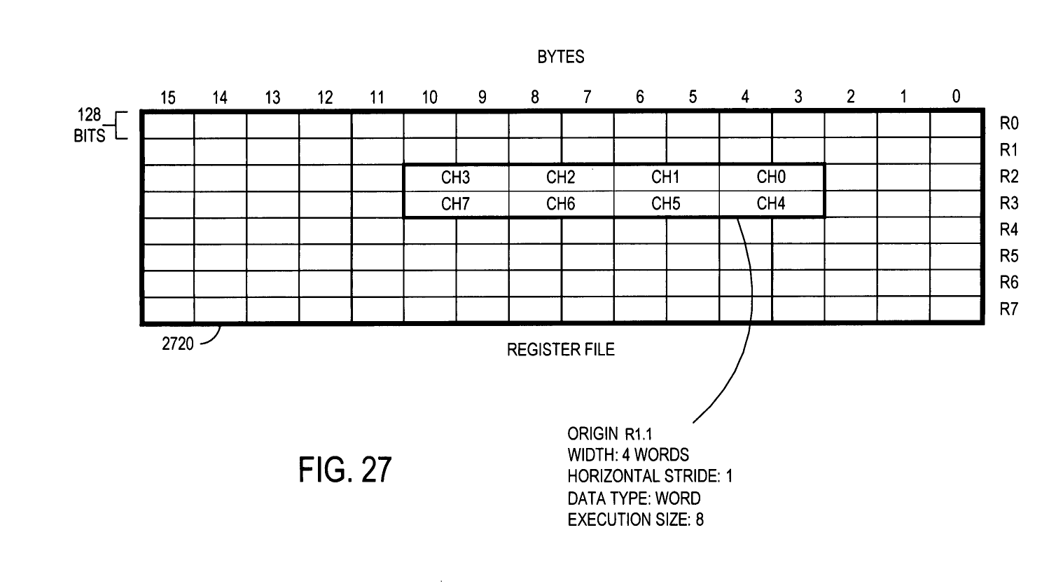

FIG. 27 illustrates a region description including a horizontal stride of “zero” according to some embodiments. As with FIG. 26, the region is for eight single-byte data elements and is four bytes wide (and therefore two data elements high). Because the horizontal stride is zero, however, each of the four elements in the first row map to the same physical location in the register file 820 (e.g., they are offset from their neighboring data element by zero). As a result, the value in R1.1 is replicated for the first four execution channels. When the region is associated with a source operand of an “add” instruction, for example, that same value would be used by all the first four execution channels. Similarly, the value in R2.1 is replicated for the last four execution channels.

According to some embodiments, the value of a horizontal stride may be encoded in an instruction. For example, a 3-bit field might be used to describe the following eight potential horizontal stride values: 0, 1, 2, 4, 8, 16, 32, and 64. Moreover, a negative horizontal stride may be described according to some embodiments.

Note that a region may be described for data elements of various sizes. For example, FIG. 27 illustrates a region description for word type data elements according to some embodiments. In this case, the register file 2720 has eight sixteen-byte registers (R0 through R7, each having 128 bits), and the region begins at R2.3. The execution size is eight channels, and the width of the region is four data elements. Moreover, each data element is described as being one word (two bytes), and therefore the data element associated with the first execution channel (CH0) occupies both byte 3 and 4 of R2. Note that the horizontal stride of this region is one. In addition to byte and word type data elements, embodiments may be associated with other types of data elements (e.g., bit or float type elements).

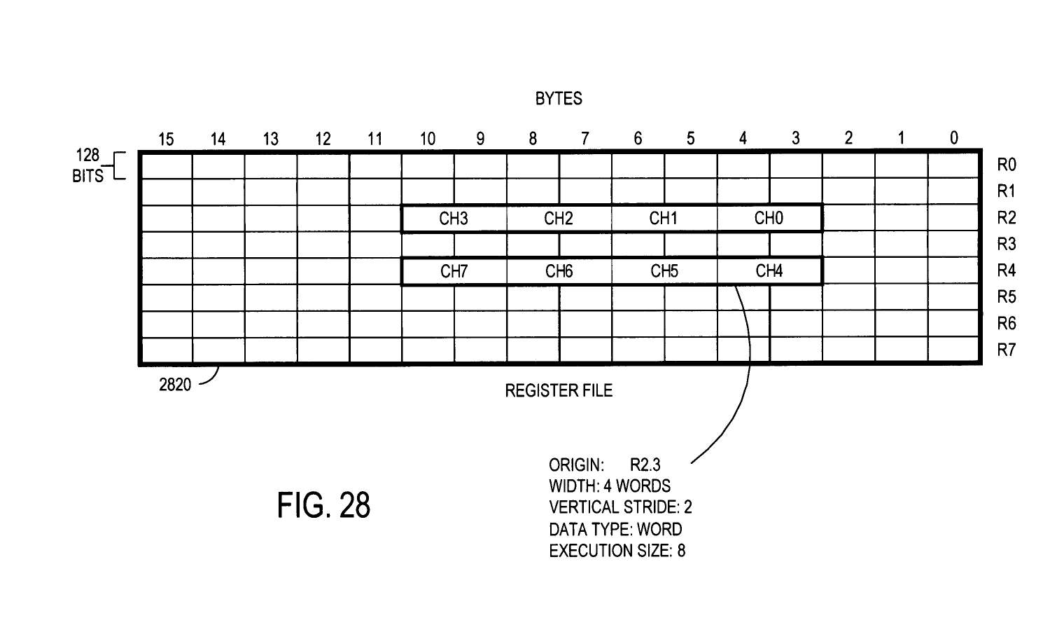

FIG. 28 illustrates a region description including a “vertical stride” according to some embodiments. The vertical stride might, for example, indicate a row offset between rows of data elements in a register file 2820. As in FIG. 27, the register file 2820 has eight sixteen-byte registers (R0 through R7), and the region begins at R2.3. The execution size is eight channels, and the width of the region is four single word data elements (implying a row height of two for the region). In this case, however, a vertical stride of two has been described. As a result, each data element in a column is offset from its neighboring data element in that column by two registers. For example, the data element associated with channel 3 of the execution engine is located at bytes 9 and 10 of R2 and the data element associated with channel 7 is located at bytes 9 and 10 of R4. As with the horizontal stride, the described region is not contiguous in the register file 1020. Note that when a vertical stride of one is described, the result would be a contiguous 4×2 array of words beginning at R2.3 in the two dimensional map of the register file 1020.

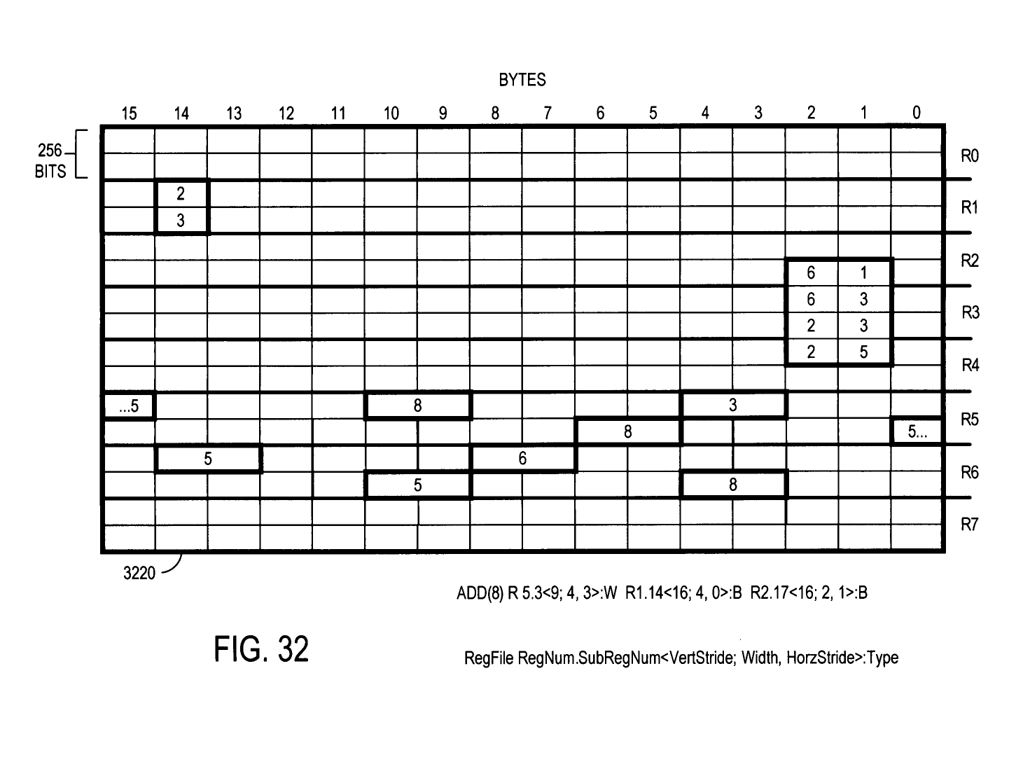

The region described in FIG. 28 might be associated with a source operand, in which case data may be gathered from the non-contiguous areas when an instruction is executed. The region described in FIG. 28 might also be associated with a destination operand, in which case results may be scattered to the non-contiguous areas when an instruction is executed. According to some embodiments, a vertical stride might be described as data element column offset betweens rows of data elements (e.g., as described with respect to FIG. 32). Also note that a vertical stride might be less than, greater than, or equal to a horizontal stride.

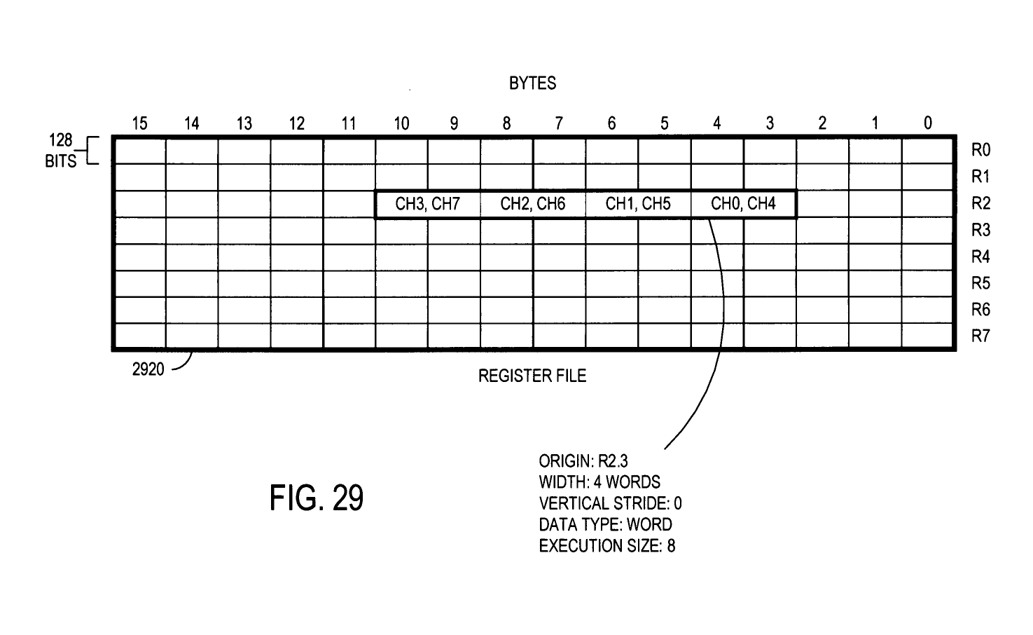

FIG. 29 illustrates a region description including a vertical stride of “zero” according to some embodiments. As with FIGS. 27 and 28, the region is for eight single-word data elements and is four words wide (and therefore two data elements high). Because the vertical stride is zero, however, both of the elements in the first column map to the same location in the register file 2920 (e.g., they are offset from each other by zero). As a result, the word at bytes 3-4 of R2 is replicated for those two execution channels (e.g., channels 0 and 4). When the region is associated with a source operand of a “compare” instruction, for example, that same value would be used by both execution channels. Similarly, the word at bytes 5-6 of R2 is replicated for the channels 1 and 5 of the SIMD execution engine, etc. In addition, the value of a vertical stride may be encoded in an instruction, and, according to some embodiments, a negative vertical stride may be described.

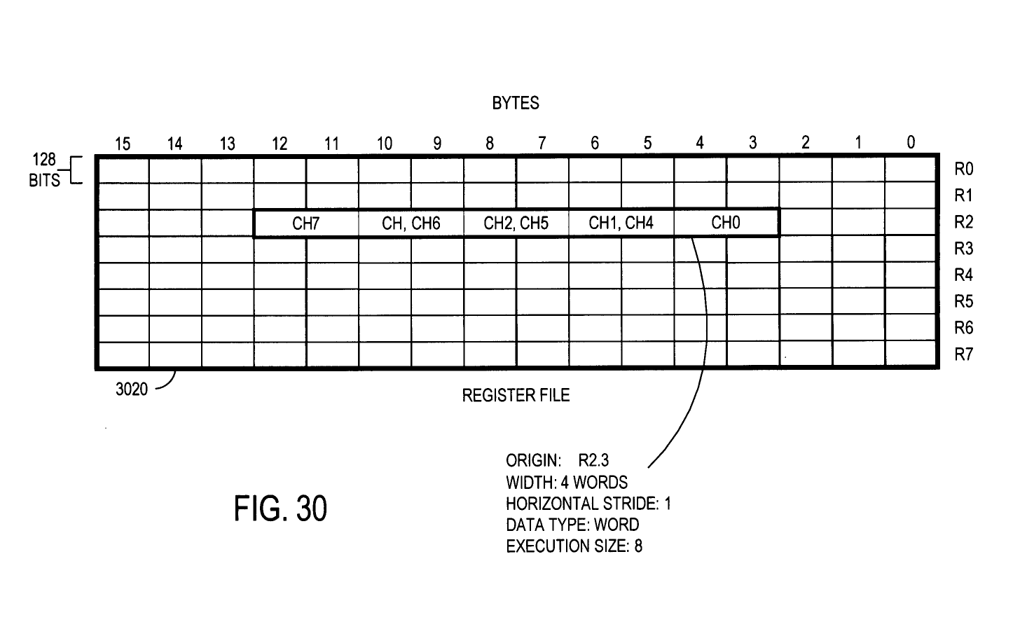

According to some embodiments, a vertical stride might be defined as a number of data elements in a register file (instead of a number of register rows). For example, FIG. 30 illustrates a region description having a 1-data element (1-word) vertical stride according to some embodiments. Thus, the first “row” of the array defined by the region comprises four words from R2.3 through R2.10. The second row is offset by a single word and spans from R2.5 through R2.12. Such an implementation might be associated with, for example, a sliding window for a filtering operation.

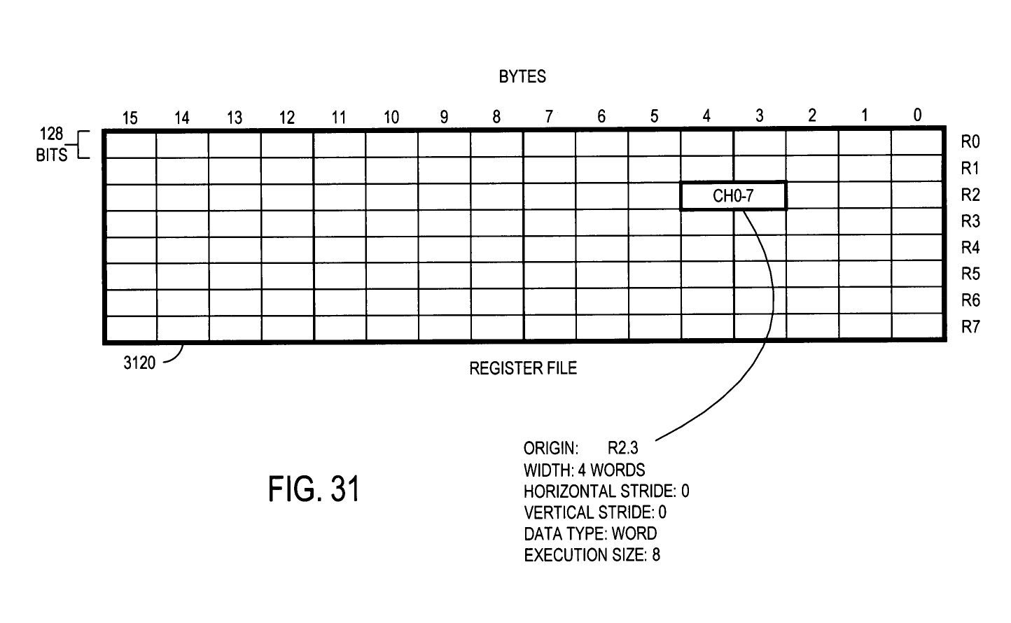

FIG. 31 illustrates a region description wherein both the horizontal and vertical strides are zero according to some embodiments. As a result, all eight execution channels are mapped to a single location in the register file 3120 (e.g., bytes 3-4 of R2). When the region is associated with a machine code instruction, therefore, the single value at bytes 3-4 of R2 may be used by all eight of the execution channels.

Note that different types of descriptions may be provided for different instructions. For example, a first instruction might define a destination region as a 4×4 array while the next instruction defines a region as a 1×16 array. Moreover, different types of regions may be described for a single instruction.

Consider, for example, the register file 3220 illustrated in FIG. 32 having eight thirty-two-byte registers (R0 through R7, each having 256 bits). Note that in this illustration, each register is shown as being two “rows” and sample values are shown in each location of a region.

In this example, regions are described for an operand within an instruction as follows:
RegFile RegNum.SubRegNum<VertStride; Width, HorzStride>:type
   where RegFile identifies the name space for the register file 3220, RegNum points a register in the register file 3220 (e.g., R0 through R7), SubRegNum is a byte-offset from the beginning of that register, VertStride describes a vertical stride, Width describes the width of the region, HorzStride describes a horizontal stride, and type indicates the size of each data element (e.g., “b” for byte-size and “w” for word-size data elements). According to some embodiments, SubRegNum may be described as a number of data elements (instead of a number of bytes). Similarly, VertStride, Width, and HorzStride could be described as a number of bytes (instead of a number of data elements).

FIG. 32 illustrates a machine code add instruction being executed by eight channels of a SIMD execution engine. In particular, each of the eight bytes described by R2.17<16; 2, 1>b (SRC1) are added to each of the eight bytes described by R1.14<16; 4, 0>:b (SRC0). The eight results are stored in each of the eight words described by R5.3<18; 4, 3>:w (DEST).

SRC1 is two bytes wide, and therefore four data elements high, and begins in byte 17 of R2 (illustrated in FIG. 32 as the second byte of the second row of R2). The horizontal stride is one. In this case, the vertical stride is described as a number of data element columns separating one row of the region from a neighboring row (as opposed to a row offset between rows as discussed with respect to FIG. 28). That is, the start of one row is offset from the start of the next row of the region by 16 bytes. In particular, the first row starts at R2.17 and the second row of the region starts at R3.1 (counting from right-to-left starting at R2.17 and wrapping to the next register when the end of R2 is reached). Similarly, the third row starts at R3.17.

SRC0 is four bytes wide, and therefore two data elements high, and begins at R1.14. Because the horizontal stride is zero, the value at location R1.14 (e.g., “2” as illustrated in FIG. 32) maps to the first four execution channels and value at location R1.30 (based on the vertical stride of 16) maps to the next four execution channels.

DEST is four words wide, and therefore two data elements high, and begins at R5.3. Thus, the execution channel will add the value “1” (the first data element of the SRC0 region) to the value “2” (the data element of the SRC1 region that will be used by the first four execution channels) and the result “3” is stored into bytes 3 and 4 of R5 (the first word-size data element of the DEST region).

The horizontal stride of DEST is three data elements, so the next data element is the word beginning at byte 9 of R5 (e.g., offset from byte 3 by three words), the element after that begins at bye 15 of R5 (shown broken across two rows in FIG. 32), and the last element in the first row of the DEST region starts at byte 21 of R5.

The vertical stride of DEST is eighteen data elements, so the first data element of the second “row” of the DEST array begins at byte 7 of R6. The result stored in this DEST location is “6” representing the “3” from the fifth data element of SRC0 region added to the “3” from the SRC1 region which applies to execution channels 4 through 7.

Because information in the register files may be efficiently and flexibly accessed in different ways, the performance of a system may be improved. For example, machine code instructions may efficiently be used in connection with a replicated scalar, a vector of a replicated scalar, a replicated vector, a two-dimensional array, a sliding window, and/or a related list of one-dimensional arrays. As a result, the amount of data moves, packing, unpacking, and or shuffling instructions may be reduced—which can improve the performance of an application or algorithm, such as one associated with a media kernel.

Note that in some cases, restrictions might be placed on region descriptions. For example, a sub-register origin and/or a vertical stride might be permitted for source operands but not destination operands. Moreover, physical characteristics of a register file might limit region descriptions. For example, a relatively large register file might be implemented using embedded Random Access Memory (RAM), and the cost and power associated with the embedded RAM might depended on the number of read and write ports that are provided. Thus, the number of read and write points (and the arrangement of the registers in the RAM) might restrict region descriptions.

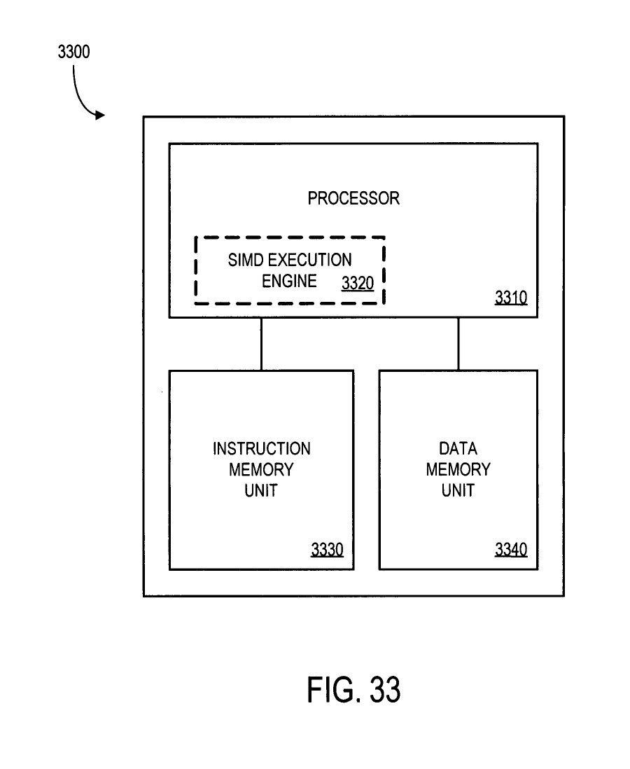

FIG. 33 is a block diagram of a system 3300 according to some embodiments. The system 3300 might be associated with, for example, a media processor adapted to record and/or display digital television signals. The system 3300 includes a processor 3310 that has an n-operand SIMD execution engine 3320 in accordance with any of the embodiments described herein. For example, the SIMD execution engine 3320 might include a register file and an instruction mapping engine to map operands to a dynamic region of the register file defined by an instruction. The processor 3310 may be associated with, for example, a general purpose processor, a digital signal processor, a media processor, a graphics processor, or a communication processor.

The system 3300 may also include an instruction memory unit 330 to store SIMD instructions and a data memory unit 3340 to store data (e.g., scalars and vectors associated with a two-dimensional image, a three-dimensional image, and/or a moving image). The instruction memory unit 3330 and the data memory unit 3340 may comprise, for example, RAM units. Note that the instruction memory unit 3330 and/or the data memory unit 3340 might be associated with separate instruction and data caches, a shared instruction and data cache, separate instruction and data caches backed by a common shared cache, or any other cache hierarchy. According to some embodiments, the system 3300 also includes a hard disk drive (e.g., to store and provide media information) and/or a non-volatile memory such as FLASH memory (e.g., to store and provide instructions and data).

The following illustrates various additional embodiments. These do not constitute a definition of all possible embodiments, and those skilled in the art will understand that many other embodiments are possible. Further, although the following embodiments are briefly described for clarity, those skilled in the art will understand how to make any changes, if necessary, to the above description to accommodate these and other embodiments and applications.

Although various ways of describing source and/or destination operands have been discussed, note that embodiments may be use any subset or combination of such descriptions. For example, a source operand might be permitted to have a vertical stride while a vertical stride might not be permitted for a destination operand.

Note that embodiments may be implemented in any of a number of different ways. For example, the following code might compute the addresses of data elements assigned to execution channels when the destination register is aligned to a 256-bit register boundary:

| | |
|---|---|
| // Input: | Type: b \| ub \| w \| uw \| d \| ud \| f |
| // | RegNum: In unit of 256-bit register |
| // | SubRegNum: In unit of data element size |
| // | ExecSize, Width, VertStride, HorzStride: In unit of data |
| | elements |
| // Output: | Address[0:ExecSize−1] for execution channels |

```
int ElementSize = (Type==“b”||Type==“ub”) ?
1 : (Type==“w”|Type==“uw”) ? 2 : 4;
int Height = ExecSize / Width;
int Channel = 0;
int RowBase = RegNum<<5 + SubRegNum * ElementSize;
for (int y=0; y<Height; y++) {
    int Offset = RowBase;
    for (int x=0; x<Width; x++) {
        Address [Channel++] = Offset;
        Offset += HorzStride*ElementSize;
    }
    RowBase += VertStride * ElementSize;
}
```

According to some embodiments, a register region is encoded in an instruction word for each of the instruction's operands. For example, the register number and sub-register number of the origin may be encoded. In some cases, the value in the instruction word may represent a different value in terms of the actual description. For example, three bits might be used to encode the width of a region, and “011” might represent a width of eight elements while “100” represents a width of sixteen elements. In this way, a larger range of descriptions may be available as compared to simply encoding the actual value of the description in the instruction word.

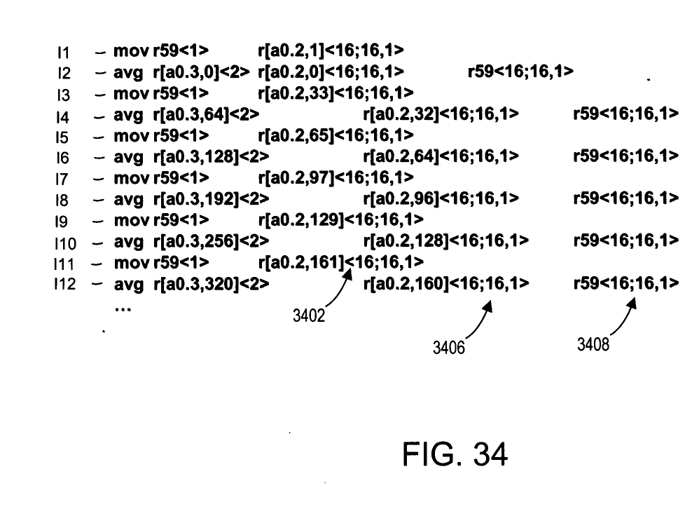

FIG. 34 is a list of instructions 11 through 112 for a program that may be compiled, assembled, and/or executed in a processing system, for example, one or more of the processing systems disclosed herein, according to some embodiments.

Execution of the first, third, fifth, seventh, ninth and eleventh instructions may each move data (e.g., data stored in an indirectly-addressed register) to a buffer (e.g., a temporary register buffer). Execution of the second, fourth, sixth, eighth, tenth and twelfth instructions may each provide interpolation.

Operands for the instructions may be described as follows:
RegFile RegNum.SubRegNum<VertStride; Width, HorzStride>:type

As can be seen, the list of instructions may include a plurality of portions, e.g., portions 3402, 3406, 3408, with a repeating pattern, which will result in binary language instructions with a repeating bit pattern.

In some embodiments, compaction and/or decompaction may be employed in association with a processing system having instructions with a length of 128 bits.

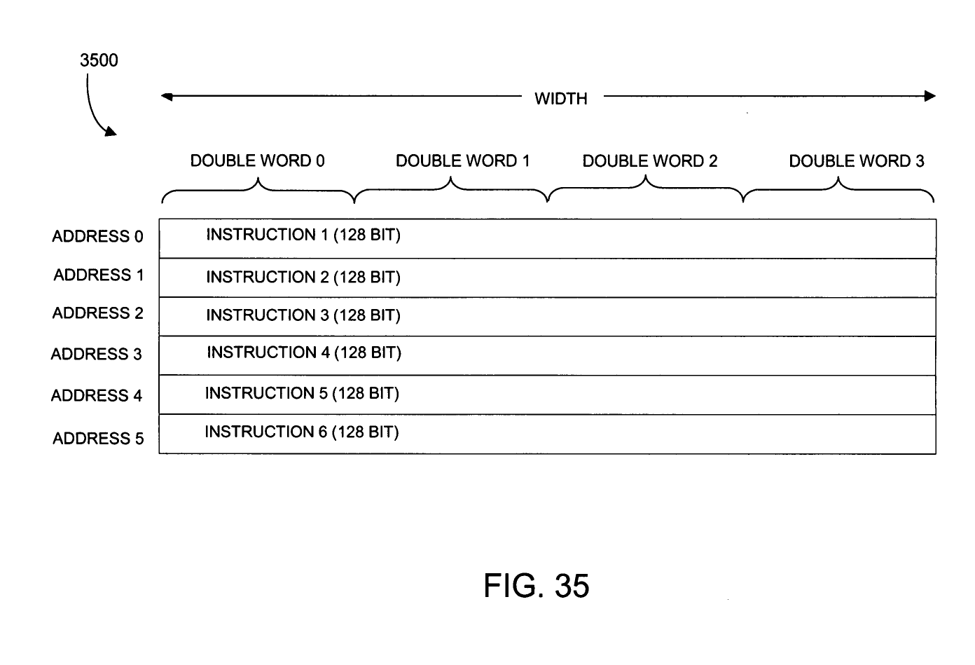

FIG. 35 is a block diagram representation of a data structure 3500 that may include a plurality of instructions according to some embodiments. Referring to FIG. 35, the data structure 3500 may include a plurality of instructions, e.g., instruction 1 through instruction 6. Each of the instructions may have a length of 128 bits. The data structure 3500 may further include a plurality of locations as well as a plurality of addresses, e.g., address 0-address 5, associated therewith. Each of the plurality of instruction may be stored at a respective location in the data structure.

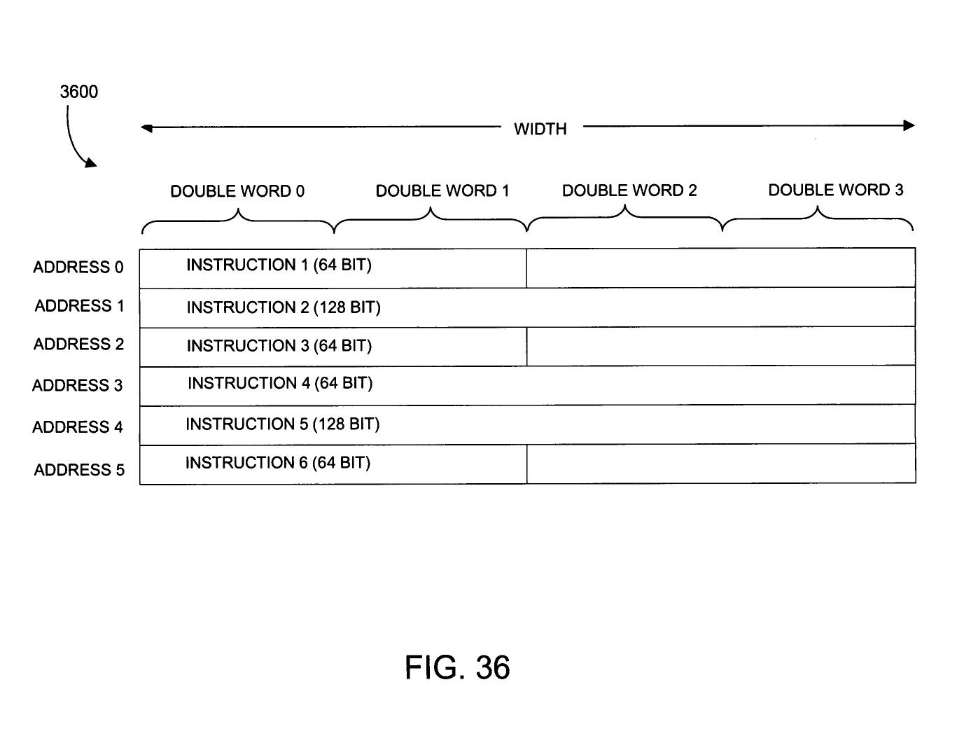

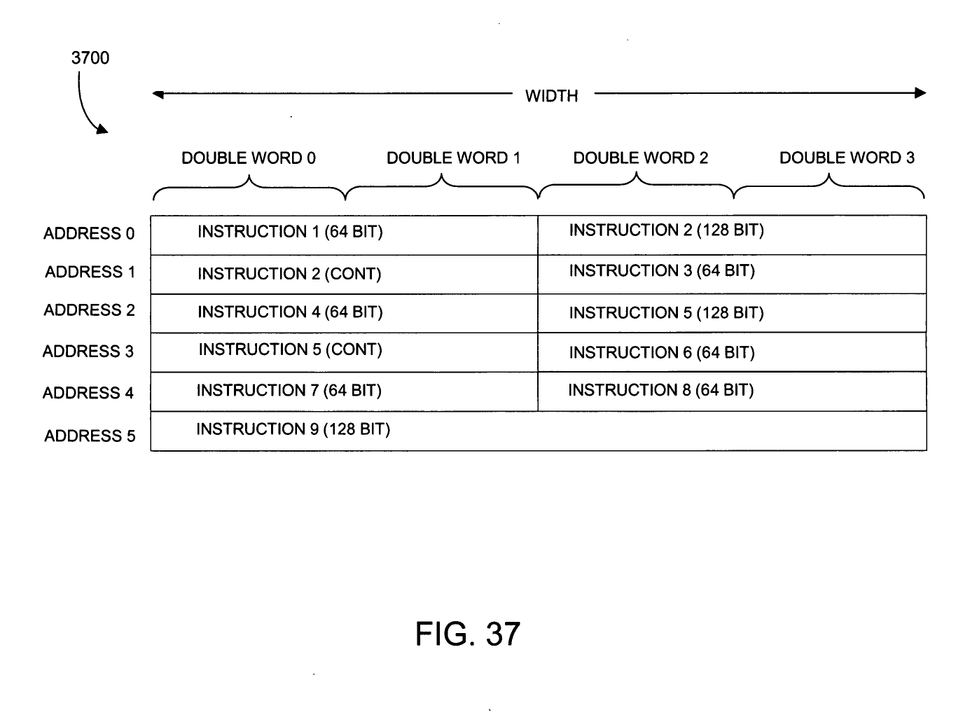

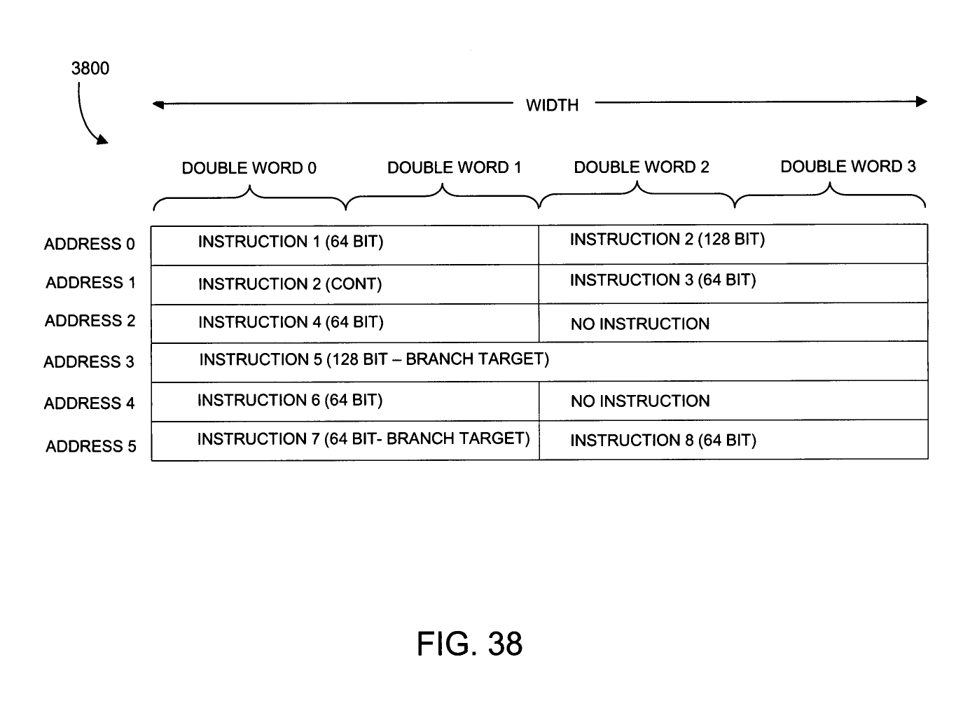

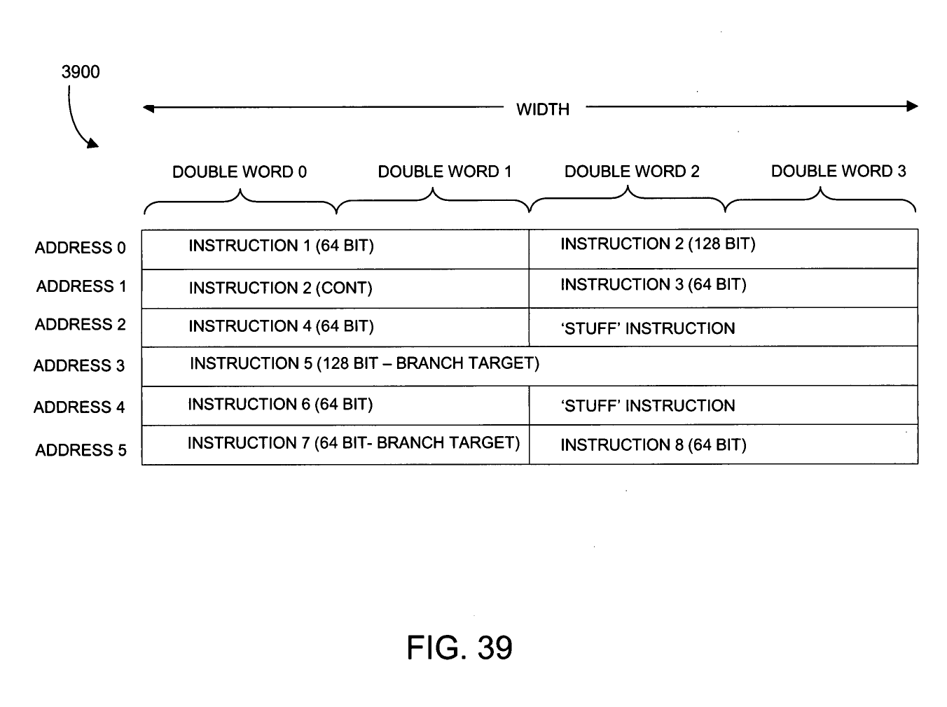

FIGS. 36-39 are block diagram representations of data structures 3600-3800 that may include a plurality of instructions according to some embodiments. Each of the data structures may include one or more compact instruction. In some embodiments, one or more of such compact instructions may be compacted and/or decompacted in accordance with one or more embodiments, or portions thereof, set forth herein. Non compact instructions may have a length of 128 bits. Compact instructions may have a length equal to half that of non compact instructions, i.e., 64 bits, but may not be limited to such.

In some embodiments, compaction may be employed in association with a processing system having one or more instructions with operands that may be described as follows:
RegFile RegNum.SubRegNum<VertStride; Width, HorzStride>:type

As shown above, in some embodiments, such instructions may have one or more portions with a bit pattern that is found in two or more instructions.

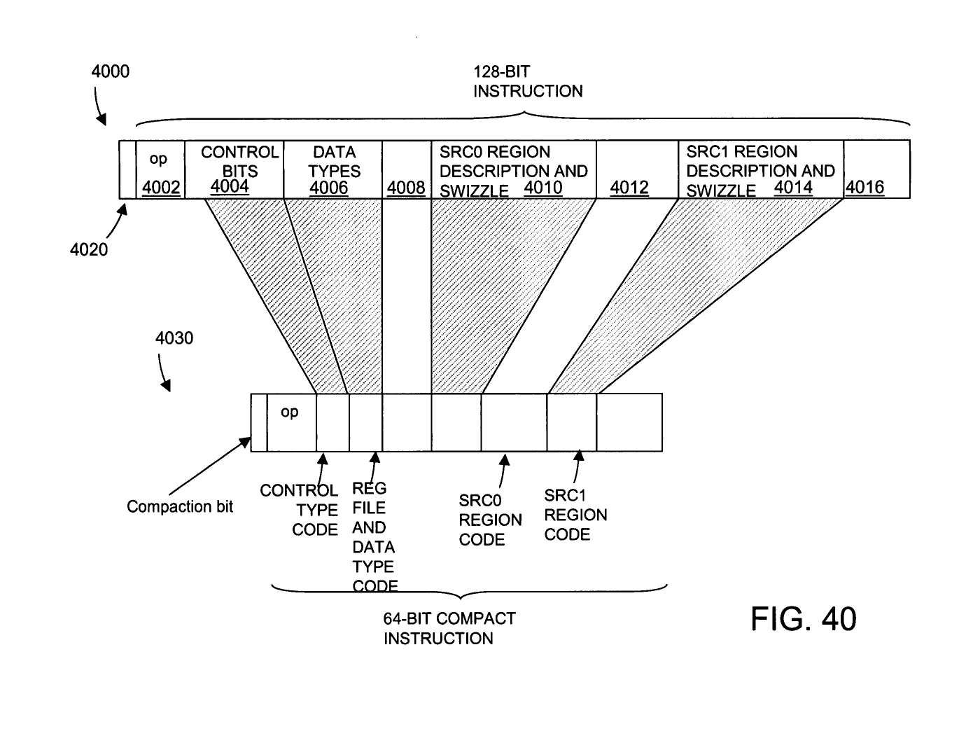

FIG. 40 is a block diagram representation of compaction according to some embodiments. In some embodiments, such compaction may be employed in association with a processing system having one or more instructions with operands that may be described as follows:
RegFile RegNum.SubRegNum<VertStride; Width, HorzStride>:type

In some embodiments, a first instruction 4000 includes a first portion 4002, a second portion 4004, a third portion 4006, a fourth portion 4008, a fifth portion 4010, a sixth portion 4012, a seventh portion 4014, an eighth portion 4016 and a ninth portion 4020. The first portion may specify an op code, the second portion may specify a plurality of control bits (e.g., thread, mask, etc), the third portion may specify a register file and data types, the sixth portion may specify a first source operand description and swizzle, and the eighth portion specifies a second source operand description and swizzle. The ninth portion may specify whether the instruction is a compact instruction.

In some embodiments, the second portion and the third portion each comprise a total of eighteen bits and the sixth portion and the eighth portion each comprise a total of twelve bits.

A compact instruction 4030 may also have nine portions. In some embodiments, the second, third, fifth and seventh portions may be compacted portions, e.g., as shown. The first, fourth, sixth and eighth portions may be noncompacted portions.

In some embodiments, the data structure has a width equal to four double words, e.g., double word 0-double word 3. Each of the six instructions may have a length equal to four double words. The compact instruction may have fewer bits than the non-compact instruction. That is, the original instruction may have a first number of bits and the compact instruction may have a second number of bits less than the first number of bits. In some embodiments, the second number of bits is less than or equal to one half the first number of bits. In some such embodiments, the original instruction comprises a total of 128 bits and the compact instruction comprises a total of 64 bits. In some embodiments, each of the compacted portions comprises three bits.

In some embodiments, decompaction may be employed in association with a processing system having one or more instructions with operands that may be described as follows:
RegFile RegNum.SubRegNum<VertStride; Width, HorzStride>:type

In some embodiments, for example, such decompaction may correspond to and/or be used in association with the compaction described hereinabove with respect to FIG. 40.

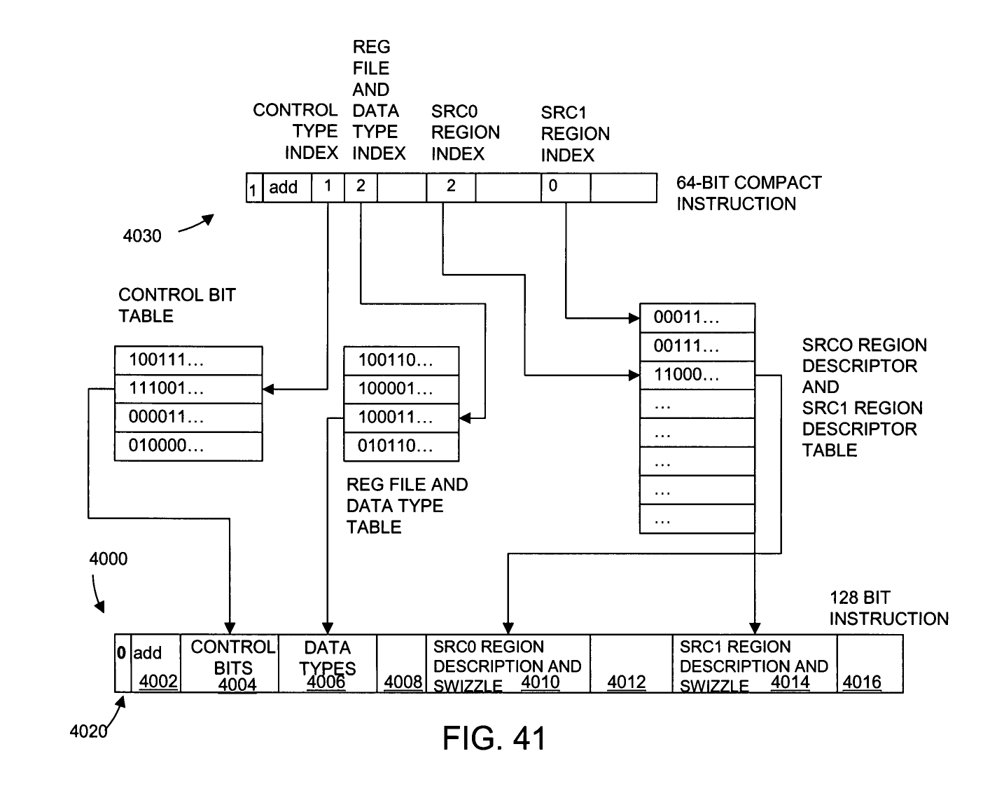

FIG. 41 is a block diagram representation of decompaction according to some embodiments. In some embodiments, such decompaction may be employed in association with the compaction described hereinabove with respect to FIG. 40.

Unless otherwise stated, terms such as, for example, “based on” mean ““based at least on”, so as not to preclude being based on, more than one thing. In addition, unless stated otherwise, terms such as, for example, “comprises”, “has”, “includes”, and all forms thereof, are considered open-ended, so as not to preclude additional elements and/or features. In addition, unless stated otherwise, terms such as, for example, “a”, “one”, “first”, are considered open-ended, and do not mean “only a”, “only one” and “only a first”, respectively. Moreover, unless stated otherwise, the term “first” does not, by itself, require that there also be a “second”.

Some embodiments have been described herein with respect to a SIMD execution engine. Note, however, that embodiments may be associated with other types of execution engines, such as a Multiple Instruction, Multiple Data (MIMD) execution engine.

The several embodiments described herein are solely for the purpose of illustration. Persons skilled in the art will recognize from this description other embodiments may be practiced with modifications and alterations limited only by the claims.

What is claimed is:

1. A method comprising:
receiving, in a first processing system, a data structure representing a plurality of instructions for a second processing system;
determining, for at least one instruction of the plurality of instructions, whether the instruction can be replaced by a compact instruction for the second processing system; and
generating, for the at least one instruction, a compact instruction based at least in part on the instruction, if the instruction can be replaced by a compact instruction for the second processing system.

2. The method of claim 1 further comprising defining a criterion that defines whether an instruction for the second processing system can be replaced by a compact instruction for the second processing system.

3. The method of claim 2 wherein determining whether the instruction can be replaced by a compact instruction for the second processing system comprises determining whether the instruction satisfies the criterion.

4. The method of claim 1 wherein the compact instruction includes a field indicating that the compact instruction is a compact instruction.

5. The method of claim 1 further comprising replacing the instruction with the compact instruction.

6. The method of claim 1 wherein the first processing system comprises a compiler.

7. The method of claim 1 wherein the first processing system comprises an assembler.

8. The method of claim 1 wherein determining, for at least one instruction of the plurality of instructions, whether the instruction can be replaced by a compact instruction for the second processing system comprises:
determining, for each instruction of the plurality of instructions, whether the instruction can be replaced by a compact instruction for the second processing system.

9. The method of claim 8 wherein generating, for the at least one instruction, a compact instruction based at least in part on the instruction, if the instruction can be replaced by a compact instruction for the second processing system comprises:
generating, for each instruction of the plurality of instructions, a compact instruction based at least in part on the instruction, if the instruction can be replaced by a compact instruction for the second processing system.

10. The method of claim 9 wherein the compact instruction includes at least one compacted portion and at least one non compacted portion.

11. The method of claim 9 wherein the compact instruction includes a plurality of compacted portions and a plurality of non compacted portion.

12. The method of claim 1 wherein the compact instruction includes at least one compacted portion and at least one non compacted portion.

13. The method of claim 1 wherein the compact instruction includes a plurality of compacted portions and a plurality of non compacted portion.

14. A method comprising:
receiving an instruction in a processing system;
determining whether the instruction is a compact instruction; and
generating a decompacted instruction based at least in part on the instruction, if the instruction is a compact instruction.

15. The method of claim 14 wherein receiving an instruction in a processing system comprises receiving the instruction at an execution engine of the processing system.

16. The method of claim 15 wherein receiving the instruction at an execution engine comprises receiving the instruction at an instruction cache of the execution engine.

17. The method of claim 14 wherein determining whether the instruction is a compact instruction comprises determining whether the instruction includes a field indicating that the instruction is a compact instruction.

18. The method of claim 14 further comprising replacing the instruction with the decompacted instruction if the instruction is a compact instruction.

19. The method of claim 14 further comprising decoding the decompacted instruction if the instruction is a compact instruction and decoding the instruction if the instruction is not a compact instruction.

20. The method of claim 14 wherein the compact instruction includes at least one compacted portion and at least one non compacted portion.

21. The method of claim 20 wherein generating a decompacted instruction comprises generating a decompacted instruction that includes:
the at least one non compacted portion of the compact instruction; and
at least one decompacted portion, each decompacted portion of the at least one decompacted portion of the decompacted instruction corresponding to a respective compacted portion of the at least one compacted portion of the compact instruction.

22. The method of claim 20 wherein generating a decompacted instruction comprises generating, for each compacted portion of the at least one compacted portion, a decompacted portion based at least in part on the compacted portion.

23. The method of claim 22 further comprising defining a table having a plurality of entries, wherein generating a decompacted portion based at least in part on the compacted portion comprises:
selecting an entry of the plurality of entries based at least in part on the corresponding compacted portion; and
generating the decompacted portion in response to the selected entry.

24. The method of claim 23 wherein each entry has an address and wherein selecting an entry comprises selecting an entry having an address corresponding to the compacted portion.

25. An apparatus comprising:
circuitry to receive an instruction, to determine whether the instruction is a compact instruction, and to generate a decompacted instruction based at least in part on the instruction, if the instruction is a compact instruction.

26. The apparatus of claim 25 wherein the circuitry comprises circuitry to determine whether the instruction includes a field indicating that the instruction is a compact instruction.

27. The apparatus of claim 25 wherein the circuitry comprises circuitry to decode the decompacted instruction if the instruction is a compact instruction and to decoding the instruction if the instruction is not a compact instruction.

28. A system comprising:
circuitry to receive an instruction, to determine whether the instruction is a compact instruction, and to generate a decompacted instruction based at least in part on the instruction, if the instruction is a compact instruction; and
a memory unit to store the instruction.

29. The system of claim 28 wherein the circuitry comprises circuitry to determine whether the instruction includes a field indicating that the instruction is a compact instruction.

30. The system of claim 28 wherein the circuitry comprises circuitry to decode the decompacted instruction if the instruction is a compact instruction and to decoding the instruction if the instruction is not a compact instruction.
